(19) United States
(12) Patent Application Publication
(10) Pub. No.: US 2022/0119249 A1
(43) Pub. Date: Apr. 21, 2022

(54) A CATALYST COMPOSITION AND METHOD OF MAKING THEREOF FOR PURE HYDROGEN PRODUCTION

(71) Applicant: UNIVERSITI KEBANGSAAN MALAYSIA, Selangor (MY)

(72) Inventors: Mohd Ambar YARMO, Selangor (MY); Wan Nor Roslam WAN ISAHAK, Selangor (MY); Maratun Najiha ABU TAHARI, Selangor (MY); Alinda SAMSURI, Selangor (MY); Tengku Shafazila TENGKU SAHARUDDIN, Selangor (MY); Fairous SALLEH, Selangor (MY); Mohammad KASSIM, Selangor (MY); Mohamed Wahab MOHAMED HISAM, Selangor (MY); Masli Irwan ROSLI, Selangor (MY); Muhammad Rahimi YUSOP, Selangor (MY)

(21) Appl. No.: 17/605,566

(22) PCT Filed: May 12, 2020
(86) PCT No.: PCT/MY2020/050029

§ 371 Date: Oct. 21, 2021

(30) Foreign Application Priority Data
Apr. 22, 2019 (MY) PI2019002238

(51) Int. Cl. C01B 3/04; B01J 21/12; B01J 23/888; B01J 37/04; B01J 37/02; B01J 37/08; B01J 23/745; B01J 21/04; B01J 23/30; B01J 23/755; B01J 21/08; B01J 38/12

(52) U.S. Cl. CPC C01B 3/045; C01B 2203/0277; B01J 23/888; B01J 37/04; B01J 37/0213; B01J 37/082; B01J 23/745; B01J 21/04; B01J 23/30; B01J 23/755; B01J 21/08; B01J 38/12; C01B 2203/1082; C01B 2203/1094; C01B 2203/1058; B01J 21/12

(57) ABSTRACT

The present invention provides an impregnated catalyst composition for production of pure hydrogen comprising: 10 wt %-50 wt % metal oxide; 1 wt %-15 wt % promoter; and 60 wt %-90 wt % support material. Another aspect of the present invention is to provide a method of preparation of an impregnated catalyst for pure hydrogen production (10) and a method for producing pure hydrogen (20) according to the impregnated catalyst of the present invention. The present invention is able to reduce the reaction temperature by 1 to 2 folds and also able to reduce the usage of energy but maintain its good production quality. Besides, selectivity of the present invention is high, hence able to produce high purity of hydrogen.

### FIELD OF INVENTION

The present invention relates to a catalyst composition. More particularly, the present invention relates to a catalyst composition and method of making thereof for pure hydrogen production.

### BACKGROUND OF THE INVENTION

Fossil energy sources are crucial in a variety of industries including transport where demand for these energy is constantly increasing every year. According to the World Coal Institute, coal, natural gas and petroleum are estimated to run out in the next 130, 60 and 42 years. Additionally, the use of fossil fuels contributes to the release of carbon dioxide (CO₂) which causes greenhouse gases and other pollutants that affect the environment and health (Wang et al. 2012). In order to reduce dependence on fossil energy sources and reduce environmental pollution, alternative energy source which more environmentally friendly should be developed (Nakamura et al. 2013).

Hydrogen is by far the most plentiful element in the universe, making up 75% of the mass of all visible matter in stars and galaxies. Pure hydrogen is odourless, colourless and tasteless (College of the Desert, 2001). Hydrogen is currently used primarily in the production of ammonia and methanol as well as for the purposes of the refining industry. It is, however, utilized also in the metallurgical, electronic, pharmaceutical and food industries (Bicakova and Straka, 2010). Nevertheless, in the near future, hydrogen will join electricity as an important energy carrier, since it can be made safely from renewable energy sources and is virtually non-polluting. It can also be used as a fuel for zero-emissions vehicles, to heat homes and offices, to produce electricity, and to fuel aircraft (NEED, n.d). However, most hydrogen is currently produced from hydrocarbons that are non-renewable energy sources that still contribute to pollution problems (Kyoung-Soo et al. 2009).

Furthermore, pure hydrogen production is still facing challenges in the industry as production of pure hydrogen involves high maintenance of infrastructure, require high energy which lead to high cost. Hence, the production of the pure hydrogen is still not effectively managed by the industries and need improvement in order to increase its effectiveness from every aspect. One of the way is by incorporating catalysts in the reaction for production of pure hydrogen so that the reaction could save more energy while still maintaining the quality of hydrogen produced.

Catalysts are substances that are added to a reaction to increase its rate of reaction by providing an alternate reaction pathway with a lower activation energy (Ea). However, the journey of finding the best catalyst remain unresolved, therefore it is a challenge to the chemists to find the best catalyst which can reduce the usage of energy, cost and time effectively.

There are several prior arts which disclosed the involvement of catalyst for pure hydrogen production and U.S. Pat. No. 5,830,425, GB 2053947A, U.S. Pat. No. 4,069,304 and US 20020114762A1 are to be mentioned. In details, U.S. Pat. No. 5,830,425 disclosed iron catalyst impregnated with a solution of salts, GB 2053947A disclosed a catalyst impregnated with several solutions, U.S. Pat. No. 4,069,304 disclosed wet impregnated of char or lime with metal catalyst, US 20020114762A1 disclosed ruthenium catalyst is impregnated onto zirconia oxide. Although the presence of the catalyst manages to reduce the energy involved in the reaction, it is best to find other alternative that able to reduce the energy significantly lower and at the same time maintain the quality and effectiveness of the produced hydrogen so that lots of energy, cost and time could be saved efficiently.

Besides, it is also important to find a catalyst which is able to selectively promotes the production of pure hydrogen without poisoning the end product or will choked during the reaction.

Therefore, improvement of catalysts is still in need in order to demonstrate much better method for pure hydrogen production with better quality and effectiveness.

### SUMMARY OF THE INVENTION

An aspect of the present invention is to provide an impregnated catalyst composition for production of pure hydrogen comprising: 10 wt %-50 wt % metal oxide; 1 wt %-15 wt % promoter; and 60 wt %-90 wt % support material.

Accordingly, the metal oxide of the present invention selected from all the d block elements.

Accordingly, the promoter metal oxide of the present invention is selected from zirconium oxide, nickel oxide, molybdenum oxide, niobium oxide, ruthenium oxide, rhodium oxide, palladium oxide, argentum oxide, chromium oxide, vanadium oxide, manganese oxide, iron oxide, copper oxide, zinc oxide, iridium oxide, tungsten oxide, platinum oxide and gold oxide. In details, the promoter metal oxide is in the form of nitrate salt.

Accordingly, the metal oxide-support material is selected from the list of aluminium oxide, silica oxide, zirconium oxide, zinc oxide and tin oxide.

Another aspect of the present invention is to provide a method of preparation of an impregnated catalyst for pure hydrogen production comprising steps of: (i) providing a single metal oxide powder, promote and support material; (ii) adding the metal oxide powder, the promoter and the support material into an aqueous salt with a corresponding metal cation to form a mixture; (iii) stirring the mixture to form an impregnated catalyst; and (iv) drying and calcining the impregnated catalyst.

Accordingly, the metal oxide in step (i) is selected from all the d block elements.

Accordingly, the promoter in step (i) is selected from zirconium oxide, nickel oxide, molybdenum oxide, niobium oxide, ruthenium oxide, rhodium oxide, palladium oxide, argentum oxide, chromium oxide, vanadium oxide, manganese oxide, iron oxide, copper oxide, zinc oxide, iridium oxide, tungsten oxide, platinum oxide and gold oxide. In details, the promoter metal oxide in step (i) is in the form of nitrate salt.

Accordingly, the support material in step (i) is selected from the list of aluminium oxide, silica oxide, zirconium oxide, zinc oxide and tin oxide.

Accordingly, the stirring step in step (iii) is conducted for 4-5 hours at 40° C.-80° C.

Accordingly, the drying step in step (iv) is conducted at a temperature of 110° C.-150° C. for overnight.

Accordingly, the calcining step in step (iv) is conducted at a temperature of 400° C.-600° C.

Accordingly, the impregnated catalyst is prepared with a ratio of 10 wt %-50 wt % metal oxide; 1 wt %-15 wt % promoter; and 60 wt %-90 wt % support material.

Yet, another aspect of the present invention is to provide a method for producing pure hydrogen comprising the steps of; (i) reacting an impregnated catalyst according to Claim 1 to Claim 5 with water to form metal oxide and produce selectively pure hydrogen; and (ii) reacting the metal oxide with carbon monoxide to regain the impregnated catalyst for reuse; wherein the steps occur simultaneously within at least a reactor, thereby the selectively pure hydrogen is collected at a temperature range of 400° C.-800° C.

Advantageously, the catalyst of the present invention is able to reduce the reaction temperature by 1 to 2 folds with reaction temperature ranges from 400° C.-800° C.

Advantageously, the present invention is able to reduce the usage of energy but maintain its good production quality.

Advantageously, selectivity of the present invention is high, hence able to produce high purity of hydrogen.

### BRIEF DESCRIPTION OF THE DRAWINGS OF THE PRESENT INVENTION

The examples are presented only to illustrate the preferred embodiments of the present invention and not intended in any way to limit the scope of the present invention.

FIG. 1 illustrates the method of preparation of an impregnated catalyst for pure hydrogen production;

FIG. 2 illustrates the method for producing pure hydrogen;

FIG. 3 illustrates catalysts preparation method;

FIG. 4 illustrates instrument schematic;

FIG. 5(a) illustrates sample tube;

FIG. 5(b) illustrates sample tube components;

FIG. 6 illustrates example of Pulse Chemisorption Water Vapour (PCWV) profile for sample after water splitting reaction (hydrogen production);

FIG. 7 illustrates summary of experimental design in production of hydrogen (Reaction 2);

FIG. 8 illustrates Temperature Program Reduction (TPR) profile reduction of Fe₂O₃ under CO (10% in N2);

FIG. 9 illustrates quantity of hydrogen profile for 20 times water vapour dosing of Fe₂O₃ catalyst at varying reduction temperature (400° C.-800° C.);

FIG. 10 illustrates X-ray powder diffraction (XRD) profile of Fe₂O₃ after oxidation (water splitting) at varying reduction temperature;

FIG. 11 illustrates percentage of hydrogen yield for Fe₂O₃ catalyst at varying reduction temperature;

FIG. 12 illustrates quantity of hydrogen profile for 20 times water vapour dosing of Fe₂O₃ catalyst at varying reduction temperature (400° C.-700° C.);

FIG. 13 illustrates percentage of hydrogen yield for Fe₂O₃ catalyst at varying oxidation temperature;

FIG. 14 illustrates quantity of hydrogen profile for 20 times water vapour dosing of Fe₂O₃ catalyst on varying type of support;

FIG. 15 illustrates percentage of hydrogen yield for Fe₂O₃ catalyst on varying support type;

FIG. 16 illustrates XRD profile of Fe₂O₃ (a) after calcined and (b-g) after reduction under CO (10% in N₂) at varying temperature;

FIG. 17 illustrates XRD profile of Fe₂O₃ after oxidation (water splitting) at varying reduction temperature;

FIG. 18 illustrates XRD profile of Fe₂O₃ after oxidation (water splitting) at varying oxidation temperature;

FIG. 19 illustrates FESEM morphology of Fe₂O₃ after reduction at temperature (a) 500 (b) 600 (c) 700 and (d) 800° C. with 10,000× magnification;

FIG. 20 illustrates proposed phases transformation in production of hydrogen via redox reaction using Fe₂O₃ catalyst;

FIG. 21 illustrates TPR profile of (a) undoped WO₃ (b) 10% Ni/WO₃ (c) 15% Ni/WO₃ and 25% Ni/WO₃ in 40% (CO in N₂) atmosphere;

FIG. 22 illustrates hydrogen quantity profile of WO₃ and Ni/WO₃ catalysts for 20 times water vapour dose;

FIG. 23 illustrates hydrogen yield profile of WO₃ and Ni/WO₃ catalysts at 1, 10 and 20 water vapour dose;

FIG. 24 illustrates hydrogen quantity profile of WO₃ and 15% Ni/WO₃ catalysts for 20 times water vapour dose at varying reduction temperature;

FIG. 25 illustrates hydrogen yield profile of WO₃ and Ni/WO₃ catalysts at 1, 10 and 20 water vapour dose at varying reduction temperature;

FIG. 26 shows proposed illustration as a result of a reduction reaction at temperatures of 800° C. and 850° C.;

FIG. 27 illustrates hydrogen quantity profile of WO₃ and 15% Ni/WO₃ catalysts for 20 times water vapour dose at varying oxidation temperature;

FIG. 28 illustrates hydrogen yield profile of WO₃ and Ni/WO₃ catalysts at 1, 10 and 20 water vapour dose at varying reduction temperature;

FIG. 29 illustrates hydrogen quantity profile of 15% Ni/WO₃ catalyst for 20 times water vapour dose at varying nitrogen flow rate;

FIG. 30 illustrates hydrogen yield profile of 15% Ni/WO₃ catalyst at 1, 10 and 20 water vapour dose at varying nitrogen flow rate;

FIG. 31 illustrates XRD diffractogram of (a) undoped WO₃, (b) 10% Ni/WO₃, (c) 15% Ni/WO₃ and 25% Ni/WO₃ calcined at 600° C.;

FIG. 32 illustrates XRD diffractogram of (a) undoped WO₃, (b) 10% Ni/WO₃, (c) 15% Ni/WO₃ and 25% Ni/WO₃ reduced at 900° C. under 40% (CO in N₂) atmosphere;

FIG. 33 illustrates XRD difractogram after reduction reaction at 850° C. dan after oxidation reaction 750° C. for 20, 50 dan 100 times water vapour dose of 15% Ni/WO₃ catalyst;

FIG. 34 illustrates FESEM image of (i) WO₃, (ii) NiO and (iii) 15% Ni/WO₃ calcined at 600° C.;

FIG. 35 illustrates FESEM image of 15% Ni/WO₃ catalyst (a) after reduced at 850° C., (b) after oxidation 20 dose, (c) after oxidation 50 dose and after oxidation 100 dose;

FIG. 36 illustrates proposed phases transformation in production of hydrogen via redox reaction using 15% Ni/WO₃ catalyst;

FIG. 37 illustrates TPR analysis profile for NiO catalyst;

FIG. 38 illustrates hydrogen quantity profile up to 20 times water vapour dose for 5% NiO catalyst with different support;

FIG. 39 illustrates hydrogen yield (%) profile up to 20 times water vapour dos for 5% NiO/SiO₂ catalyst with different supporter;

FIG. 40 illustrates hydrogen quantity profile up to 20 times water vapour dose for 5% NiO—SiO₂ catalyst at different reduction temperature;

FIG. 41 illustrates hydrogen yield (%) profile up to 20 times water vapour dos for 5% NiO—SiO₂ catalyst at different reduction temperature;

FIG. 42 illustrates hydrogen quantity profile up to 20 times water vapour dose for 5% NiO—SiO₂ catalyst at different oxidation temperature;

FIG. 43 illustrates hydrogen yield (%) profile up to 20 times water vapour dos for 5% NiO—SiO₂ catalyst at different oxidation temperature;

FIG. 44 illustrates hydrogen quantity profile up to 20 times water vapour dose for 5% NiO—SiO₂ catalyst at different N₂ flow rate;

FIG. 45 illustrates hydrogen yield (%) profile up to 20 times water vapour dos for 5% NiO—SiO₂ catalyst at different N₂ flow rate;

FIG. 46 illustrates XRD diffractogram for 5% NiO/SiO₂ catalyst;

FIG. 47 illustrates FESEM morphology for calcine 5% NiO/SiO₂ catalyst;

FIG. 48 illustrates FESEM morphology for 5% NiO/SiO₂ catalyst after reduction reaction;

FIG. 49 illustrates FESEM morphology for 5% NiO/SiO₂ catalyst after oxidation reaction (20 dosage of water vapour);

FIG. 50 illustrates proposed phases transformation in production of hydrogen via redox reaction using 5% NiO/SiO₂ catalyst;

FIG. 51 illustrates FESEM images which show 5% Zr/Fe₂O₃ catalyst on (a) 20,000× magnification, (b) mapping of Zr element and 10% Zr/Fe₂O₃ catalyst on (c) 20,000× magnification, (d) mapping of Zr element;

FIG. 52 illustrates TPR profile reduction of Fe₂O₃ and (1, 3, 5 and 10%) Zr doped Fe₂O₃ catalyst under CO (10% in N₂);

FIG. 53 illustrates PCWV profile for sample after hydrogen production at reduction and water splitting temperature both at 600° C.;

FIG. 54 illustrates PCWV profile for sample after hydrogen production at reduction temperature 500° C. and water splitting at temperature 600° C.;

FIG. 55 illustrates XRD diffraction for (a) ZrO₂, (b) Fe₂O₃, (c-f) Zr/Fe₂O₃ catalyst series after a reduction reaction at 600° C. temperature under CO (10% in N₂);

FIG. 56 illustrates XRD profile for 5% Zr/Fe₂O₃ after reduction reaction under CO (10% in N₂) at (a) 500° C., (b) 600° C., (c) 700° C. and (d) 800° C.;

FIG. 57 illustrates quantity of hydrogen profile produced at various oxidation reaction temperatures for 5% Zr/Fe₂O₃ catalysts with reduced temperatures maintained at 600° C.;

FIG. 58 illustrates quantity of hydrogen profile produced at various oxidation reaction temperatures for 5% Zr/Fe₂O₃ catalysts with reduced temperatures maintained at 400° C.;

FIG. 59 illustrates quantity of hydrogen profile produced at the various carrier gas flow rate (5% Zr/Fe₂O₃ catalyst);

FIG. 60 illustrates quantity of hydrogen profile produced for 5% Zr/Fe₂O₃ and Fe₂O₃ catalyst at reduction temperature of 600° C. and oxidation temperature of 400° C. Note: quantity value of hydrogen theory=10.4 mol;

FIG. 61 illustrates the quantity of hydrogen percentage produced for 5% Zr/Fe₂O₃ and Fe₂O₃ catalyst at reduction temperature of 600° C. and oxidation temperature of 400° C. Note: The percentage of hydrogen percentage theory=80%;

FIG. 62 illustrates percentage of hydrogen production of 5% Zr/Fe₂O₃ catalyst at a reduction temperature of 600° C. and an oxidation temperature of 400° C. up to 80 times the amount of water vapour which is 10 cycles of redox reaction. Note: The percentage of hydrogen percentage theory=80%;

FIG. 63 illustrates XRD diffraction of catalyst 5% Zr/Fe₂O₃ for reduction reaction in (a) cycle 1, (b) 5 and (c) cycle 10 and oxidation reaction at (d) cycle 1 (e) cycle 5 and (f) cycle 10.

### DETAILED DESCRIPTION OF THE INVENTION

An aspect of the present invention is to provide an impregnated catalyst composition for production of pure hydrogen comprising: 10 wt %-50 wt % metal oxide; 1 wt %-15 wt % promoter; and 60 wt %-90 wt % support material.

Accordingly, the metal of the present invention selected from all the d block elements.

Preferably, the metal of the present invention is selected from iron, tungsten and nickel.

In details, the impregnated catalyst of the present invention comprising iron oxide manages to yield pure hydrogen in percentage range of 58% to 66.9% and operated at reduction and oxidation temperature of 600° C. For impregnated catalyst of the present invention comprising tungsten oxide, it manages to yield pure hydrogen in percentage range of 32.1%-38.6% and operated at reduction temperature of 850° C. and oxidation temperature of 750° C. For impregnated catalyst of the present invention comprising nickel oxide, it manages to yield pure hydrogen in percentage range of 35.9%-44.6% with operating reduction temperature of 700° C. and oxidation temperature of 600° C.

Accordingly, the promoter of the present invention is selected from zirconium (Zr), nickel (Ni), molybdenum (Mb), niobium (Nb), ruthenium (Ru), rhodium (Rh), palladium (Pd), argentum (Ag), chromium (Cr), vanadium (V), manganese (Mn), iron (Fe), copper (Cu), zinc (Zn), iridium, tungsten (W), platinum (Pt) and gold (Au). In details, the promoter is in the form of nitrate salt.

Accordingly, the support material is selected from the list of aluminium oxide, silica oxide, zirconium oxide, zinc oxide and tin oxide.

Preferably, in one embodiment of the present invention, the impregnated catalyst of 5% ZrFe₂O₃ works the best for production of pure hydrogen. The impregnated catalyst of 5% ZrFe₂O₃ of the present invention able to generate hydrogen at the best condition to achieve 90.4% conversion of water vapour to hydrogen with the hydrogen percentage yielded to reach 72.3% which is very close to theoretical value (80%). Besides, the impregnated catalyst of 5% ZrFe₂O₃ of the present invention able to produce hydrogen up to 10 continuous redox reaction cycles where nearly 800 times the water vapour injection has been provided without indicating the loss of significant activity. Furthermore, the impregnated catalyst of 5% ZrFe₂O₃ of the present invention is operated at reduction and oxidation temperature of 600° C.

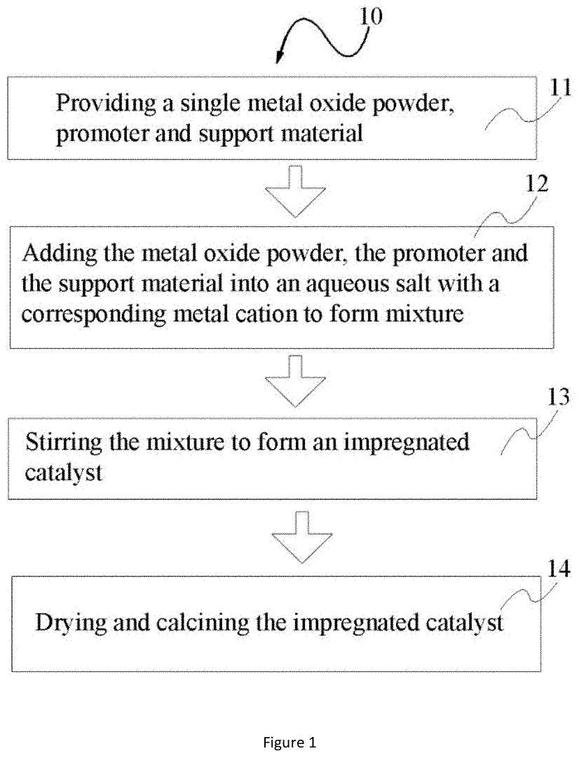

Another aspect of the present invention is related to a method (10) of preparation of an impregnated catalyst for pure hydrogen production. FIG. 1 shows in details the method of preparation of an impregnated catalyst for pure hydrogen production (10). As referring to FIG. 1, the method (10) of the present invention comprising steps of providing a single metal oxide powder, promoter and support material (11). The metal in step (11) is selected from all the d block elements. The promoter in step (11) is selected from zirconium, nickel, molybdenum, niobium, ruthenium, rhodium, palladium, argentum, chromium, vanadium, manganese, iron, copper, zinc, iridium, tungsten, platinum and gold. In details, the promoter metal in step (11) is in the form of nitrate salt. The metal oxide-support material in step (11) is selected from the list of aluminium oxide, silica oxide, zirconium oxide, zinc oxide and tin oxide.

The method of the present invention is then continued with adding the metal oxide powder, the promoter and the support material into an aqueous salt with a corresponding metal cation to form a mixture (12). Then the mixture is stirred to form an impregnated catalyst (13). The stirring in step (13) is conducted for 4-5 hours at 40° C.-80° C.

The method of the present invention is further continued with drying and calcining the impregnated catalyst (14). The drying step in step (14) is conducted at a temperature of 110° C.-150° C. for overnight and the calcining step in step (14) is conducted at a temperature of 400° C.-600° C.

Accordingly, the impregnated catalyst is prepared with a ratio of 10 wt %-50 wt % metal oxide; 1 wt %-15 wt % promoter-metal oxide; and 60 wt %-90 wt % metal oxide-support material.

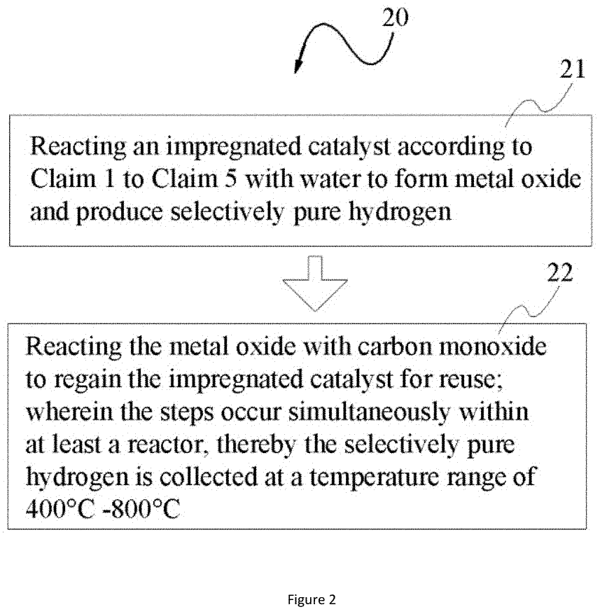

Yet, another aspect of the present invention is to provide a method for producing pure hydrogen. FIG. 2 shows in details the method for producing pure hydrogen (20). As referring to FIG. 2, the method comprising the step of reacting an impregnated catalystaccording to the present invention with water to form metal oxide and produce selectively pure hydrogen (21). Then, the method (20) is continued with reacting the metal oxide with carbon monoxide to regain the impregnated catalyst for reuse (22). In further details, the steps occur simultaneously within at least a reactor, thereby the selectively pure hydrogen is collected at a temperature range of 400° C.-800° C.

Advantageously, the catalyst of the present invention is able to reduce the reaction temperature by 1 to 2 folds with reaction temperature ranges from 400° C.-800° C.

Advantageously, the present invention is able to reduce the usage of energy but maintain its good production quality.

Advantageously, selectivity of the present invention is high, hence able to produce high purity of hydrogen.

The production of hydrogen from a more environmentally friendly and efficient technology is the right choice as a clean energy source. The generation of hydrogen from the reducible source is through the thermochemical water and water electrolysis process is well known process. However, the thermochemical cycle method is more efficient than the electrolysis process. It is because the method involves several steps in the process of splitting water molecules into hydrogen and oxygen by using only heat energy (Abanades et al. 2008).

The proper use of thermochemical cycles is important to help overcome high temperature problems during the water splitting in addition to being more environmentally friendly. Thermochemical cycles with metal redox oxide pairs are the easiest and do not cause much environmental problems. The thermochemical process is carried out through two steps of metal oxide redox reaction cycle:

Endothermic reaction (Step 1), reduction of metal oxide catalyst to metal and oxygen gas by using heat energy is as in Eq. 1,

$$MO -> M ° + {CO}_{2} \qquad ( Equation 1 )$$

Exothermic reaction (Step 2) in which the production of hydrogen and metal oxide catalysts from the water splitting as shown in Eq. 2 and then the metal oxide recycled through the first step.

$$M + {H}_{2} O -> {H}_{2} + MO \qquad ( Equation 2 )$$

Where M is metal.

According to the thermodynamic calculations indicated that the use of iron oxide (Fe₂O₃), tungsten oxide (WO₃), nickel oxide (NiO) for the production of hydrogen via catalytic water splitting reaction were favourable. The potential metal oxide proceeds to preliminary experimental analysis. This process involves a cycle of two-step reaction as in Eq. 1 and Eq. 2. The reduction reaction of the catalyst (metal oxide) will be used carbon monoxide (CO) obtained from reaction 1 (R1) followed by an oxidation reaction to split the water molecules to produce hydrogen that will be use in reaction 3 (R3). The performance of prepared catalysts was discussed in term of hydrogen quantity and yield produced. The catalyst prepared were characterized by using temperature programmed reduction (TPR), pulse chemisorption water vapour (PCWV), X-ray diffractometry (XRD) and scanning electron microscopy (FESEM).

The present invention will be explained in more details through the examples below. The examples are presented only to illustrate the preferred embodiments of the present invention and not intended in any way to limit the scope of the present invention.

### Example 1

### Methodology

### Materials

The major chemicals used as precursor for formation of catalyst (metal oxide) and gases as follows:

TABLE 1
List of chemicals used

| Chemicals | Chemical Formula and Purity | Usage |
|---|---|---|
| Iron oxide | Fe₂O₃ (99%) | Catalyst |
| Tungsten oxide | WO₃ (99%) | Catalyst |
| Nickel nitrate | (Ni(NO3)2•6H₂O (99%) | Promoter |
| Aluminium oxide | Al₂O₃ (98.98%) | Support |
| Silica oxide | SiO2 (98.98%) | Support |
| Carbon monoxide gas | CO in N₂ | Reducing agent |
| | (10 and 40 v/v %) | |
| Nitrogen gas | N₂ (99.8%) | GC Carrier |
| Helium gas | He | GC Carrier |
| Argon gas | Ar (99.8%) | GC Carrier |
| Liquid nitrogen | N₂ (99.8%) | Cooling agent for |
| | | Physisorption |

### Catalyst Preparation

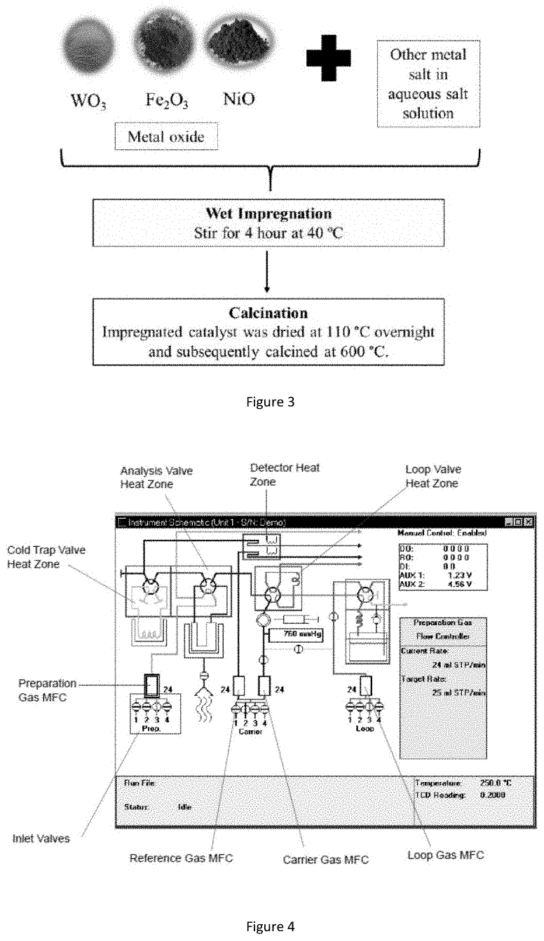

The doped metal oxide was prepared by impregnating metal oxide powder with an aqueous salt solution. The amount of promoter was adjusted to be equal to desired wt % of promoter metal. The metal oxide powder was directly mixed with 50 ml of the corresponding metal cation additives and stirred vigorously for 4-5 h at 40° C. The impregnated sample was dried at 110° C. overnight and subsequently calcined at 600° C. Supporting materials work as a stabilizer for active sites such as metals and metal oxides. There are several types of support material that used in this research namely aluminum oxide (Al₂O₃) and silica oxide (SiO₂). The supporting material was added to the catalyst to study the effect of adding support to hydrogen production. However, the metal oxide alone catalyst ready to be used after the calcination. The summary of catalyst preparation is presented in the FIG. 3.

### Catalyst Performance of Hydrogen Production

Investigation of a primary characteristic of metal oxides was implemented in order to study the possible of metal oxide that could undergo both reduction and re-oxidation at low temperature to produce hydrogen. There are several metal oxides that either easily reduced or re-oxidised at lower temperature, but very few oxides are able being both reduced and oxidised within at low narrow range of temperatures.

Hydrogen production consist of two steps:

i. Reduction Reaction (MO+CO→M°+CO2) (R2A)

ii. Oxidation Reaction (M°+H2O→MO+H2 (R2B)

Overall Reaction: CO+H2O→H2+CO2 (R2)

### Reduction (TPR) Reaction

Production of hydrogen using a two-step method involving a reduction reaction which is the most important reaction. The reduction reaction of selected oxide metal catalysts was carried out using the Temperature Program Reduction (TPR) technique using Chemisorption Analyzer model Micromeritics Autochem II as mini reactor. The carbon monoxide consumption was monitored using a thermal conductivity detector (TCD). This instrument consists of heating furnace for sample analysis up to 1100° C., cold traps to remove water vapour, vapour generation for steam production and “kwick cool” components for immediate cooling purposes. FIG. 4 is a schematic diagram to illustrate the flow of gas occurring during the TPR analysis process.

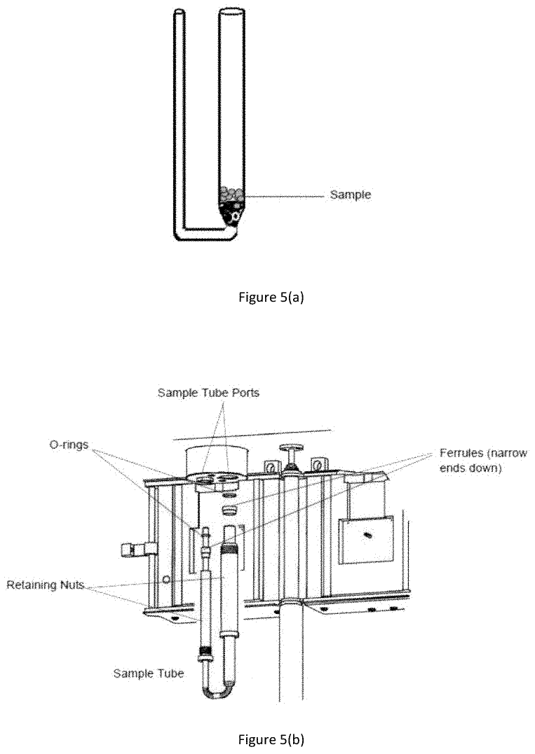

A 50-60 mg of sample was loaded into U-shaped quartz tubes as shown in FIG. 5(a) which was loaded with quartz cotton first. Then the tubes are attached to the TPR analysis tool as shown in FIG. 5(b) and heated up to 150° C. in the gas stream N2 to remove adsorbing and drying of the samples. After being cooled to 40° C., (10% or 40%) CO in N2 (20 ml/min) gas streamed and the temperature program started (10° C./min).

### Oxidation (Water Splitting) Reaction

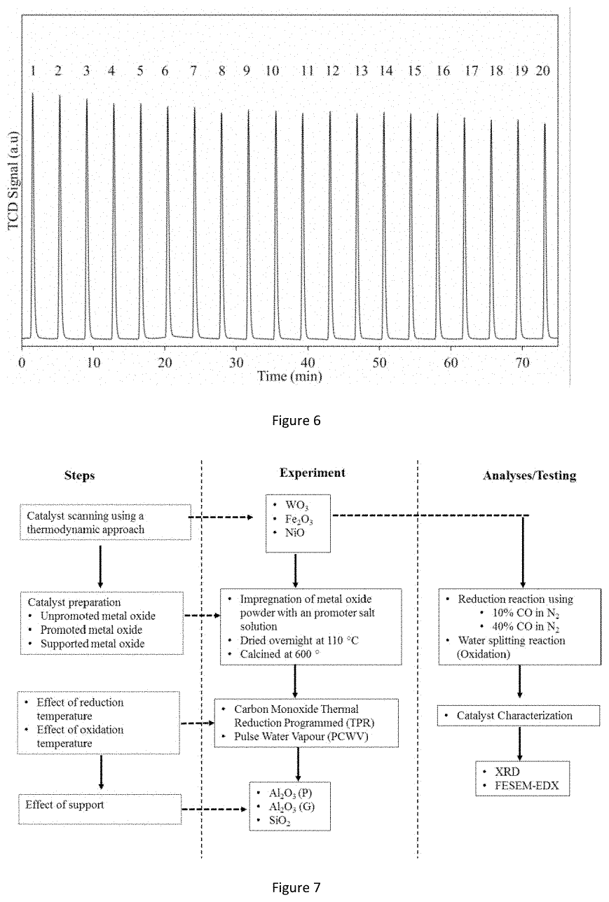

After the reduction reaction was completed the reaction proceed to an oxidation reaction (water splitting) by using Pulse Chemisorption Water Vapour (PCWV) for the production of hydrogen which using similar tools as TPR. The temperature programming of this analysis involves the rate of pulses by using water vapour under the N₂ gas stream. Through this technique, the vaporized water vapour will be absorbed by the catalyst. The profile for the use of water vapour is recorded as shown in FIG. 6. The information from the profile is the quantity of hydrogen produced on every pulse (dose) of water vapour. FIG. 7 shows a schematic diagram to explain the flow of gas and water vapour that occur during the process of water vapour dose.

About 0.23 cm3 (10.4 μmol) of water vapour using 0.98 cm3 of sample loops in the N₂ stream dosed for each pulse to the reduced metal oxide to undergo the water splitting reaction (oxidation) to produce hydrogen. The production of hydrogen by metal oxide catalysts was studied by conducting 20 times number of water vapour doses to the reduced metal oxide. The reaction of water molecules was carried out at different temperatures at the flow rate of N₂ gas by 20 ml/min.

### Catalyst Characterization

Phase characterization of the metal oxides was carried out by X-ray diffraction (XRD) model Bruker AXSD8 Advance with CuKa (40 kV, 40 mA) X-ray radiation source. The 2q diffractions was collected from 10 to 800 at I ¼ 0.154 nm to observe the lattice parameters of the structures. In order to identify the crystalline phase com-positions, the diffraction patterns were matched with a standard diffraction (JCPDS) files. In addition, FESEM images were obtained with Merlin Ultra High Resolution FESEM operating with 3.0 kV. The composition of the gas produced from the oxidation reaction (water splitting) was detected using the GC system from the Agilent Technologies 6890N model using the TCD detector. Separation of gas was carried out using a column of Propack Q (6.0 m×⅛ in.) And Molecular Sieve 5 Å (2.0 m×⅛ in.), Both of which are connected to each other. The carrier gas used is Argon (Ar) at flow rate of 4 ml/min.

### Analysis of Reaction Yield

The analysis of the results of the water splitting reaction is based on the profile of the pulse chemisorption water vapour profile of water. The activity of a catalyst is measured by the percentage of water vapour conversion to hydrogen and the likelihood of yield or product produced during or after the reaction. The conversion of water vapour to hydrogen per dose of water vapor (10.4 μmol) is based on Equation 3.

$$Water vapour conversion ( \% ) = \frac{quantity of hydrogen ( µmol )}{20.4 µmol} \times 100 \% \qquad ( Equation 3 )$$

Whereas, hydrogen selectivity was calculated based on the equation of water splitting as Equation 4.

$$M ( p ) + {H}_{2} O ( g ) -> MO ( p ) + {H}_{2} ( g ) \qquad ( Equation 4 )$$

Therefore, the equation of determination to the percentage of hydrogen selectivity is as Equation 5.

$$Hydrogen selectivity ( \% ) = \frac{\% Hydrogen}{\% Hydrogen \times MO} \times 100 \% \qquad ( Equation 5 )$$

Whereas the percentage of hydrogen yield was calculated based on Equation 6.

Hydrogen yield (%)=Water vapour conversion×Hydrogen selectivity×100% (Equation 6)

### Example 2

### Iron Oxide Catalyst

Numerous applications of iron-based elements that have been developed which include catalysis, as adsorbs, pigments, coagulants, gas sensors, ion exchange and lubricants (Mohapatra and Anand 2010). Iron oxide has been used extensively as a catalyst in the chemical process such as in high temperature reactions for the conversion of carbon monoxide, ethylbenzene hydrogenation to the styrene, the removal of hydrogen sulfate from the reduction of the gas mixture and the production of hydrogen through the redox process, while the iron metal is used in the ammonia reaction using a process known as Fischer-Tropsch.

### Reduction Properties of Catalysts by Using CO-TPR Technique

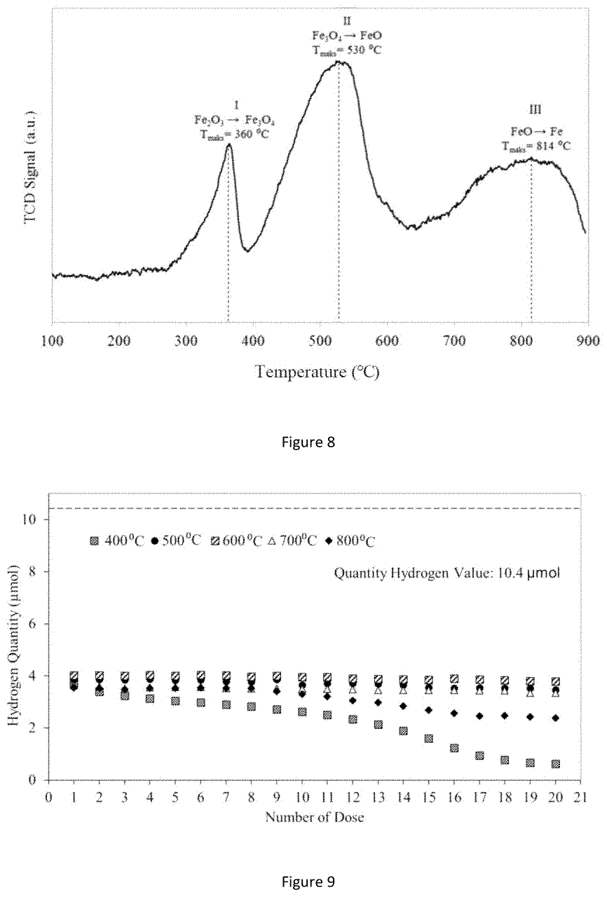

Based on the thermodynamic studies, the process of water splitting for hydrogen production requires Fe₂O₃ to be reduced first to FeO or Fe active phase. Therefore, TPR technical analysis is important to study the Fe₂O₃ reduction potential. The analysis of Fe₂O₃ reduction in non-isothermal has been shown in FIG. 8.

According to the profile in FIG. 8, there are 3 sharp peaks which clearly indicated that the Fe₂O₃ has been reduced to 3 stages. Stage I was the earliest peak at 360° C. showed Fe₂O₃ reduced to Fe₃O₄ phase which was also agreed by (Kuo et al. 2013) where that the formation of Fe₃O₄ is a mixture of Fe²⁺ and Fe³⁺ species which starts at 350° C. Whereas, peak II can be seen at 530° C. attributed to the reduction of Fe₃O₄→FeO followed by the peak III at 814° C. was the reduction of FeO→Fe.

### Hydrogen Production of Catalyst by Water Splitting by Using PCWV Technique

The reaction of hydrogen production via water splitting using Fe₂O₃ catalyst was studied in detail using a pulse chemisorption water vapour technique (PCWV). This process will start with reduction of Fe₂O₃ reaction and followed by an oxidation reaction (water splitting for hydrogen production) with a total of 1 mL of water converted into water vapour phase. In this research 0.23 mL of water vapour was used in each injection equal to 10.4 μmol H₂O. Therefore, according to the theory of theoretically the sum of the quantities of mol H₂ produced is equal to the mol water vapour supplied which is 10.4 μmol and this value becomes a benchmark and is labelled as dotted line within each resulting quantity of hydrogen graph.

### Effect of Reduction Temperature

Effect of reduction temperature on the production of hydrogen activity was studied as different reduction temperature will form different phases which affected the hydrogen yield. Reduction temperature that to low will lead to a decrease in the production of Fe or FeO active phases as the phases are stable at higher temperatures. However, when the reduction temperature is too high, the hydrogen production activity can also be low due to the occurrence of the sintering process at Fe₂O₃. Therefore, the potential of hydrogen production activity was selected from five different temperatures 400, 500, 600, 700 and 800° C. and continued with oxidation temperature at 600° C. The amount of water vapour injection of 20 times will be given to the system and the hydrogen production profile shown in FIG. 9.

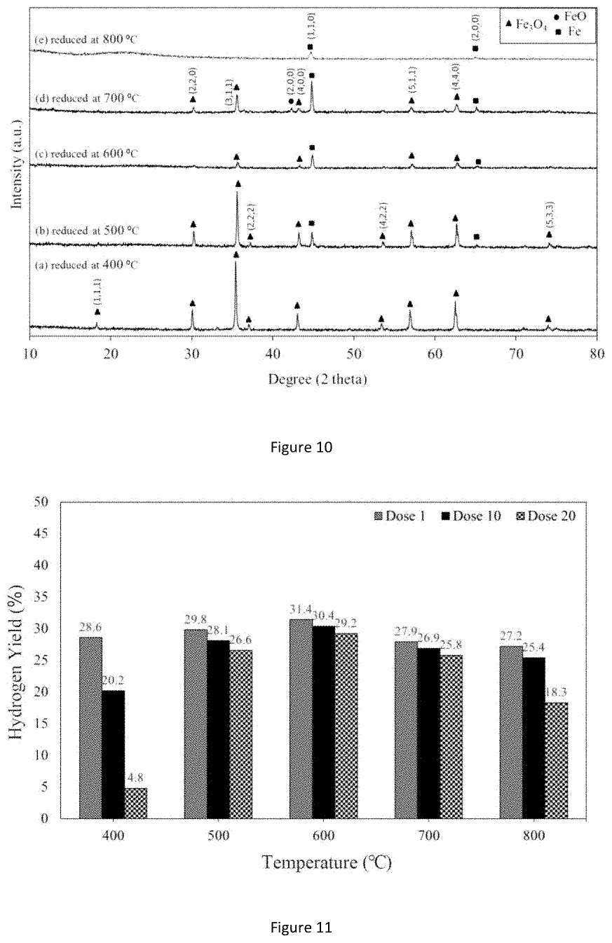

The results shown in FIG. 9 show that the hydrogen production profile is proportional to the increase in temperature until the temperature reaches 600° C. At temperature of 600° C., hydrogen production is the best and most equally hydrogen quantity in the first water vapor injection is 4.03 μmol and remains high until the 20th injection (3.79 μmol). Meanwhile, the hydrogen production profile for reduction temperature of 400° C. indicates the hydrogen quantity dropped dramatically from 3.7 μmol (1st injection) to 0.6 μmol (20th injection). This due to there was no Fe and FeO active site that can split the water molecules to produce hydrogen and this in agreement by XRD profiles derived from after oxidation reaction (water splitting) in FIG. 10. When the temperature decreased to 700 and 800° C. the hydrogen yield was decreases by 3.63 μmol and 3.54 μmol (1st injection) while at the 20th injection the values decreased slightly to 3.35 μmol and 2.38 μmol respectively due to the sintering phenomenon which occurred at high temperature (>600° C.).

$$\begin{matrix}3 Fe + 4 {H}_{2} O -> {Fe}_{3} {O}_{4} + 4 H 2 , Δ H r 29 {8}^{∘} C . = - 1 \; 51 kJ mol - 1 & ( Equation 7 ) \\ Hydrogen Yield ( \% ) = Water vapor conversion \times 0.8 \times 100 \% & ( Equation 8 )\end{matrix}$$

The percentage value of the hydrogen yield for Fe₂O₃ catalysts at varying reduction temperature at the 1st, 10th and 20th of the water vapor injections has been summarized in FIG. 11. The results showed that the highest percentage of hydrogen yield in the first water vapor injection was at a temperature of 600° C. which was the best reduction temperature selected with a hydrogen percentage of 31.4% compared to the theoretical value of 80% and the highest value also on the number.

### Effect of Oxidation Temperature

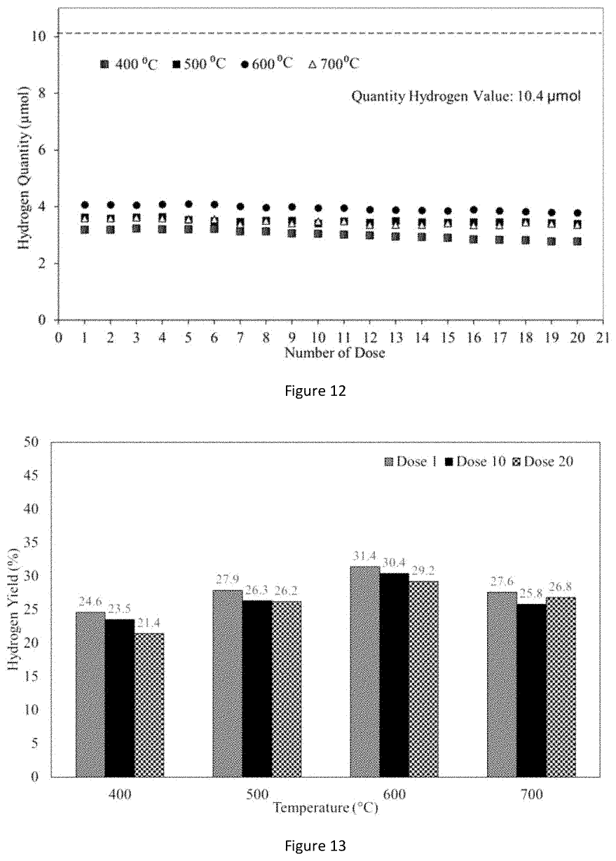

The optimum reduction reaction temperature for Fe₂O₃ catalysts was at 600° C. The effect of oxidation reaction temperature for production of hydrogen were also studied by varying oxidation temperature at 400, 500, 600 and 700° C., whereas the reduction remains at 600° C. A total of 20 times the amount of water vapour injection introduced to the system and the hydrogen quantity profile is shown in FIG. 12.

Based on the profile, the increase in oxidation temperature contributes to higher hydrogen quantity, however when temperatures increase to 700° C. the hydrogen quantity decrease due to sintering effect that occurs at high temperature. The hydrogen quantity profile produced in descending order of the first water vapour injection is summarized as follows: oxidation temperature 600° C. (4.1 μmol)>500° C. (3.6 μmol)>700° C. (3.5 μmol)>400° C. (3.2 μmol), while the 20th water vapor injection in descending order is as follows: 600° C. (3.8 μmol)>500° C. (3.4 μmol)>700° C. (3.3 μmol)>400° C. (2.8 μmol). FIG. 13 shows a hydrogen yield profile with their respective values according to the descending order of the first water vapour injection is as follows: 600° C. (31.4%)>500° C. (27.9%)>700° C. (27.6%)>400° C. (24.6%).

As a results, the optimum oxidation temperature for Fe₂O₃ catalyst is 600° C. It can be concluded that the optimum temperature of the redox reaction of Fe₂O₃ catalyst in water splitting is 600° C. for the reduction/regeneration reaction and also 600° C. for the oxidation/hydrogen production reaction.

### Effect of Support for Iron Catalyst

The effect of type of support used for Fe₂O₃ catalyst were investigated using aluminum oxide (Al₂O₃) in powder and granule forms at varying loading (10, 20 and 30%) on the production of hydrogen. Supporting Fe₂O₃ on Al₂O₃ was conducted in powder and granulate form denoted as Fe₂O₃/Al₂O₃ and Fe₂O₃/Al₂O₃ (G) respectively. The use of support material in order to increase the catalyst activity All the catalysts were performed reduction and oxidation reaction at optimum parameter which both at temperature 600° C. During the oxidation reaction, 20 times of water vapour doses were passed with a nitrogen flow rate carrying water vapour at 10 ml/min.

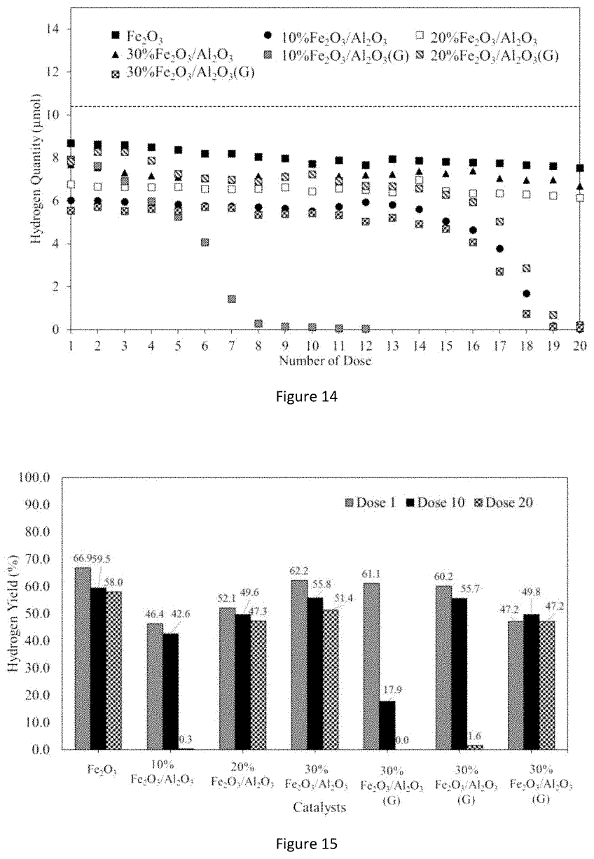

FIG. 14 shows the quantity of hydrogen for 20 times number of water vapour doses of Fe₂O₃ catalyst supported on varying type and percentage of support material. The Fe₂O₃ catalyst without support shows the highest hydrogen quantity with 8.7 μmol at Dose 1 then reduced to 7.5 μmol at Dose 20 compared to the supported Fe₂O₃ catalysts. 10% Fe₂O₃/Al₂O₃ catalyst produces 6.0 μmol of hydrogen at Dose 1 and the quantity decreases sharply at Dose 20 with 0 μmol at Dose 20. However, the quantity of hydrogen increases as the percentage of Fe₂O₃ added to support increase. 30% Fe₂O₃/Al₂O₃ catalyst gave 7.6 μmol and 6.6 μmol at Dose 1 and Dose 20 respectively as the amount catalyst increases. The result shows that 30% Fe₂O₃ on Al₂O₃ gave almost the same performance of catalyst activity. Furthermore, when the supports material used in granule form, the hydrogen quantity produced were dropped sharply. The hydrogen quantities were (Dose 1=7.9 μmol Dose 13=0 μmol), (Dose 1=7.8 μmol, Dose 20=0.2 μmol) and (Dose 1=6.9 μmol, Dose 20=6.1 μmol) for 10% Fe₂O₃/Al₂O₃(G), 20% Fe₂O₃/Al₂O₃(G) and 30% Fe₂O₃/Al₂O₃(G) respectively.

Percent of hydrogen yield is determined by the selectivity of hydrogen yield which is 80%. Theoretically the percentage of hydrogen yield (% yield=% conversion x optimum) maximum is 80%. FIG. 15 shows the percentages of hydrogen yield for Fe₂O₃ catalyst on the different supports. Fe₂O₃ catalyst without support produced the highest hydrogen yield at 66.9% at first water vapour dose and decrease to the 58% at 20th dose.

When the supporting material has a high surface area of the total number of pores, it will cause Fe₂O₃ catalyst to enter the pores and partially surface of the support material. This causes CO-exposed catalysts to carry out decreased reduction reactions. Indirectly, the amount of active sites exposed to water vapor during the molecular division of the oxidation (oxidation) for hydrogen production decreases. As a result, the hydrogen yield was directly proportional to the percentage of catalyst that is added. It can be concluded that the addition of supporting material has no significant effect on the production of hydrogen to the Fe₂O₃ catalysts.

### Crystallinity Analysis by Using XRD Technique

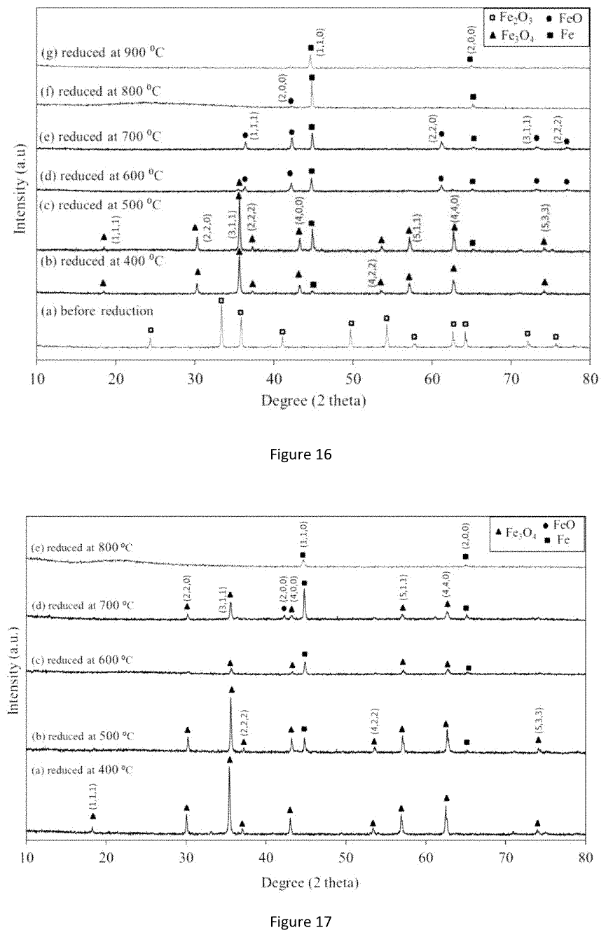

XRD analysis of reduced catalyst was carried out to observe the mechanism or phase transformation of Fe₂O₃ reduction under CO (10% in N₂) gas at 400 to 900° C. FIG. 16 shows the XRD profile that supports the pattern of TPR profile as shown in FIG. 8 where at 400° C. and 500° C., diffraction data that appears that with the is very match with the JCPDS number of pure Fe₃O₄ cube (magnetite, JCPDS 71-6336) at 20 angles of 18.5°, 30.2°, 35.6°, 37.2°, 43.2°, 53.5°, 57.1°, 62.7°, 74.1° respectively (1.1, 1), (2,20), (3,1,1), (2,2,2), (4,0,0), (5,1,1), (4,4,0), (5,3,3). In addition, the analysis obtained also showed that the Fe phase was formed at a value of 20 of 44.8° denotes the Fe lattice plane (1,1,0) at 400° C. based JCPDS 65-4899 data for Fe. The reduction at low temperature of <570° C. is normally through the transformation of Fe₂O₃→Fe₃O₄ phase. However, the Fe₃O₄ also could simultaneously reduce to Fe metal phase as the temperature may possibly permits the complete reduction as reported by (Pineau, Kanari, and Gaballah 2006). Therefore, the formation of Fe metal as early as 400° C. is based on the directly reduction of Fe₃O₄ phase Fe metal and when the temperature increased >570° C. the FeO phase took over the reduction activity to form Fe metal.

Furthermore, when the temperature reaches 500° C., another significant lattice Fe (2,0,0) at the value of 20 of 65.3° formed and the Fe lattice plane (1,1,0) appears to be significantly different from JCPDS 65-4899 for Fe. The increase in crystalline value for the Fe phase becomes more significant with temperature rise. Whereas, when the temperature reached 600° C. the Fe₃O₄ phase was transform to FeO phase at the angle of diffraction 20=36.4°, 42.2°, 61.2° representing lattice plane (1,1,1), (2,0,0) and (2, 2.0) which refers to the plane angle of the FeO cube with numbers (wustite, JCPDS 80-0686). At 700° C. and 800° C. the peak intensity of the FeO phase decreases and is completely replaced by Fe phase when the temperature to 900° C. According to the XRD and TPR profiles it can be explained that the Fe₂O₃ reduction reaction under CO (10% in N₂) through three phase stages reduces namely Fe₂O₃→Fe₃O₄→FeO→Fe and a complete reduction occurs at 900° C.

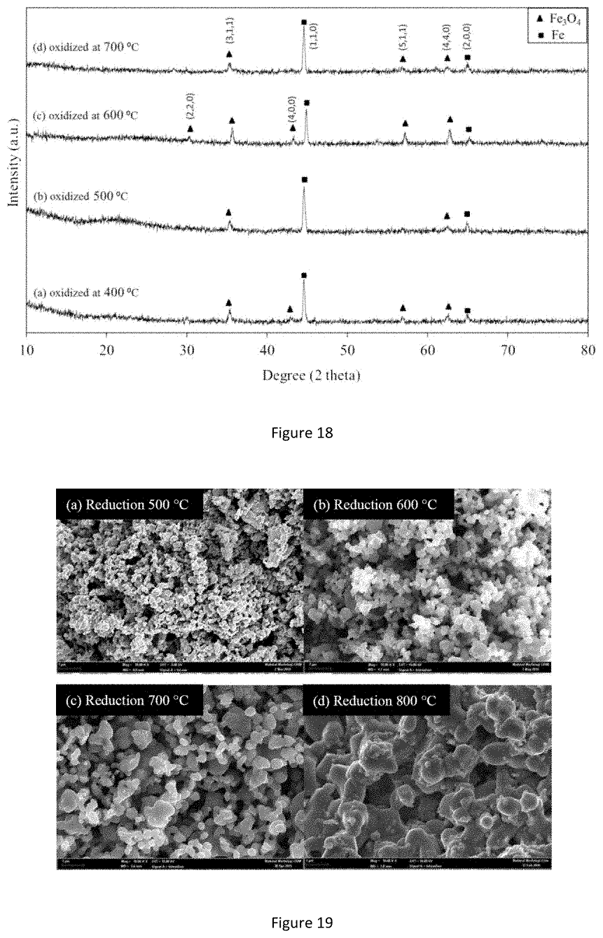

In order to study the phase changes occurs after the reaction of water splitting, the oxidized catalysts were collected after reaction and characterized using XRD technique. The XRD results of Fe₂O₃ catalysts after the oxidation reaction at varying reduction temperature shown in FIG. 17 and the XRD profile of effects of different oxidation temperatures on hydrogen production activity shown in FIG. 18.

In general, the water splitting process will release hydrogen gas while the resulting oxygen reacts with Fe metal and oxidized to the final phase of Fe₃O₄. Thermodynamically, the FeO phase is stable at a high temperature reduction of >570° C. as discussed by (Jozwiak et al. 2007) and it has been shown earlier in FIG. 16 where reduction at higher temperature of >600° C. has produced FeO phase. Based on the hydrogen production activity at each reduced temperature 400, 500, 600, 700 and 800° C., have shown their tendency to oxidize to Fe₃O₄ compared to FeO phase. The FeO phase still at temperature reduction of 700° C. is probably phase of FeO which has not responded since the hydrogen production activity at the reduction temperature is lower than when it is used at a temperature of 600° C. At the 600° C. shows the complete oxidation of FeO phase to Fe₃O₄ phase in addition to the Fe metal which has not yet reacted. As a result, 600° C. was the optimum reduction temperature for redox reaction in producing hydrogen.

Furthermore, effects of varying oxidation temperatures (400, 500, 600 and 700° C.) on the hydrogen production activity demonstrated in FIG. 18 show no significant difference was observed. It is due to each oxidation temperature exhibited the disappearance of FeO phase and transformed by the Fe₃O₄ phase and also unreactive Fe metal. The oxidation temperatures at 600° C. provide an increase in crystalline Fe₃O₄ phase compared to other oxidation temperatures and this shows that the water splitting process at this temperature is seen to be more successful.

### Morphology Analysis of Fe₂O₃ Catalyst Using FESEM Technique

FIG. 19 show the comparison of morphological properties of Fe₂O₃ catalysts which reduced under CO at varying temperatures of 500, 600, 700 and 800° C. with 10 000× enlargement. FESEM analysis has shown that the size of Fe₂O₃ particles after reduction reaction also plays an important role in the production of hydrogen for Fe₂O₃ catalysts. According to the image, as the reduction temperature increases the particle size of phase significantly increase. The Fe₃O₄ phase is the dominant phase when the Fe₂O₃ reduced at a temperature of 500° C. and the morphology shows that particles have almost spherical structures, having a fairly uniform size with each other and smaller in size compared with other temperatures studied.

### Summary

Catalyst: Fe₂O₃ powder

TABLE 2
Optimum operating parameter for production of hydrogen
using Fe₂O₃ catalyst

| Operating Parameter | Condition |
|---|---|
| Step 1: | |
| Reduction Temperature (° C.) | 600 |
| Concentration CO in Nitrogen (%) | 10 |
| Flow rate of CO gas (mL/min) | 20 |
| Step 2: | |
| Oxidation Temperature (° C.) | 600 |
| Flow rate nitrogen carrier (mL/min) | 20 |

Active phase formed after the reduction reaction were FeO and Fe plays an important role in determining the activities of the water molecular diffusion reaction for hydrogen production.

TABLE 3
Catalyst activity

| Performance | Dose 1 | Dose 20 |
|---|---|---|
| Hydrogen quantity (μmol) | 7.6 | 6.6 |
| Hydrogen yield (%) | 66.9 | 58.0 |

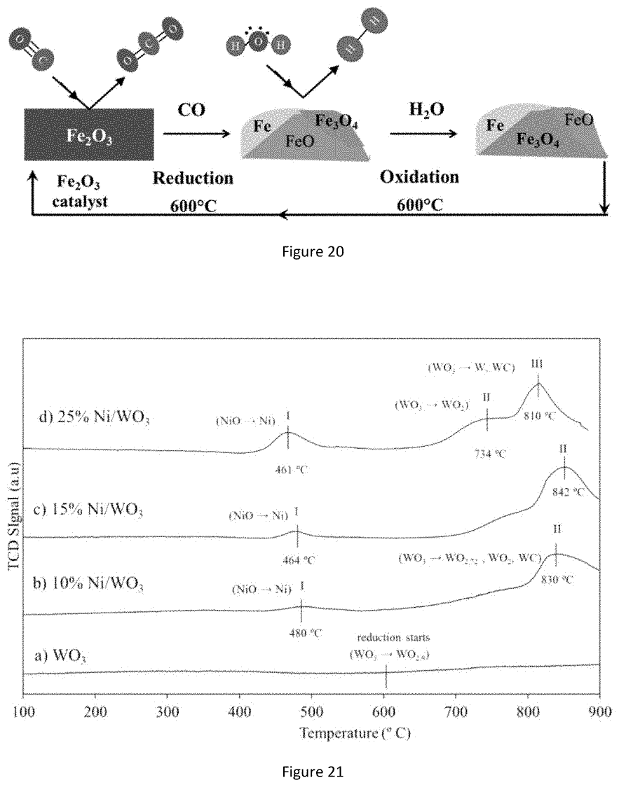

Proposed phases transformation in production of hydrogen via redox reaction using Fe₂O₃ catalyst as showed in FIG. 20.

### Conclusions

Fe₂O₃ catalyst was selected and most applicable in reaction 2 (R2) to produce hydrogen as it can easily to be reduced and re-oxidized within low range temperature (600° C.) under 10% (CO in N₂) for both reactions compared to other catalysts. Fe₂O₃ catalyst is able to produce 67% H₂ yield at first dose of water vapour and maintained at up to 58% H₂ yield for 20th dose.

### Example 2

### Tungsten Oxide Catalyst

Preliminary studies on the screening of some other metals added to the WO₃ catalyst in show that the addition of nickel metal has a very significant effect on the production of hydrogen compared to the addition of other metals. High hydrogen production by the Ni/WO₃ modified catalytic system is due to the catalyst's ability to perform a reduction reaction and then break down water molecules and subsequently oxidize the reduced metals to produce hydrogen.

Referring to previous studies, NiO oxides are a good oxygen carrier by having appropriate chemical and physical properties. NiO is an attractive metal oxide compared to other oxides because it has a high rate of reduction reaction, good fluidization, the ability to reproduce it repeatedly and is also capable of being used at high temperatures (Rashidi, Ebrahim, and Dabir 2013; Sharma, Vastola, and Walker 1997).

Reduction properties of WO₃ catalyst by using CO-TPR technique Thermodynamic assessment of tungsten oxide (WO₃) has shown it to be suitable in the production of hydrogen via two steps process (reduction and oxidation). Tungsten oxide shows favourable in both reactions for production of hydrogen, with addition of nickel the performance improved. Tungsten metal and its oxides possess high melting point, resulting in greater resistance to sintering and making it an ideal candidate for high temperature redox reaction. However, a promoter needs to be added to the WO₃ to improve their performance.

$$\begin{matrix}WO 3 + CO -> WO 2 + CO 2 = - 30 kJ \text{/} mol & ( Equation 9 ) \\ NiO + CO -> Ni + CO 2 Δ Hr = - 43 kJ \text{/} mol & ( Equation 10 )\end{matrix}$$

Effect of varying Ni content (10,15 and 25 wt %) were investigated by using a non-isothermal temperature programed reduction (TPR) under 40% (CO in N₂) at temperature up to 900° C. by TPR technique. The Ni doped WO₃ were prepared by using wet impregnation with aqueous nickel (II) solution. The catalyst with and without nickel content were denoted as (10, 15 and 25%) Ni/WO₃ and WO₃.

FIG. 21 shows the TPR profile of Ni doped WO₃ at varying loading (10, 15 and 25%) compare with undoped WO₃. Profile of undoped WO₃ shows no obvious peak up to 900° C., however reduction starts at 600° C. to form some of intermediate suboxide WO_{2.9} which was comparable to the previous study to be the initial step in the WO₃ reduction under 5% (H₂ in N₂) reported by (Zaki et al. 2011). Whereas the TPR pattern obtained for Ni/WO₃ catalyst was much contrast compared to undoped WO₃. One small peak of denoted I at temperature 461, 464, 480° C. were observed for 10% Ni/WO₃, 15% Ni/WO₃ and 25% Ni/WO₃ TPR profile respectively. It can be seen that higher Ni loading, the peaks were become more obvious. The peaks were associated to the carbon formation on the catalyst which carbon dioxide is converted into carbon dioxide and carbon (Eq 11) called as Bourdard reaction as there were no phase transformation occur at this region. However, some of NiO phase was partially reduced to metal Ni.

$$Boudouard reaction \text{:} 2 CO -> CO 2 + C \qquad ( Equation 11 )$$

Moreover, peak at temperature 830 and 842° C. denoted as II exhibited to the transformation of WO₃ to the suboxide WO_{2.72}, WO₂ and WC phases for 10% Ni/WO₃ and 15% Ni/WO₃ catalyst respectively. However, when 25% Ni added to the WO₃ catalyst, additional peak observed denoted as II at temperature 810° C. which contributed to the transformation of WO₃→W and WC, while peak II was attributed to the transformation of WO₃→WO₂. This finding in agreement to the previous study outcomes wherein the WO3 reaction takes place via two steps which are the reduction to metal W and followed by the carbonation process (Ahmed, El-Geassy, and Seetharaman 2010; Ahmed and Seetharaman 2010). It can be concluded that as the Ni promoter added, increased the ability of CO adsorption and simultaneously improve the reduction and carburization of WO3 catalyst (Mohammadzadeh et al. 2014).

### Hydrogen Production of Catalyst by Water Splitting

The effects of various Ni of Ni metals (3, 5, 10, 15 and 25 wt. %) doped WO₃ on hydrogen production were investigated by using Pulse Chemisorption Water Vapour (PCWV) technique. The reaction of hydrogen production consists of two steps; the first step is the reduction reaction by using 40% (CO in N₂) as a reduction agent at a temperature of 900° C. (10 ml/min) followed by the oxidation reaction (water splitting) were carried out at temperature 800° C. under nitrogen gas flow of 20 ml/mi n to produce hydrogen gas.

The oxidation reaction involves with dosing with water with 20 times for each dose is 0.23 cm3 (10.4 μmol).

$$\begin{matrix}{H}_{2} O -> {H}_{2} + \frac{1}{2} {O}_{2} ( Δ Hr = + 242 kJ \text{/} mol ) & ( Equation 4 ) \\ {WO}_{2} + {H}_{2} O -> {WO}_{3} + {H}_{2} ( Δ Hr = - 11 kJ \text{/} mol ) & ( Equation 5 )\end{matrix}$$

### Effect of Ni Doping at Varying Loading

The WO₃ and the Ni/WO₃ catalyst series with various percentage of Ni (10, 15 and 25%) Ni, which have been reduced at 900° C. have been passed with water vapour at 800° C. by 20 times the number of dose to produce hydrogen.

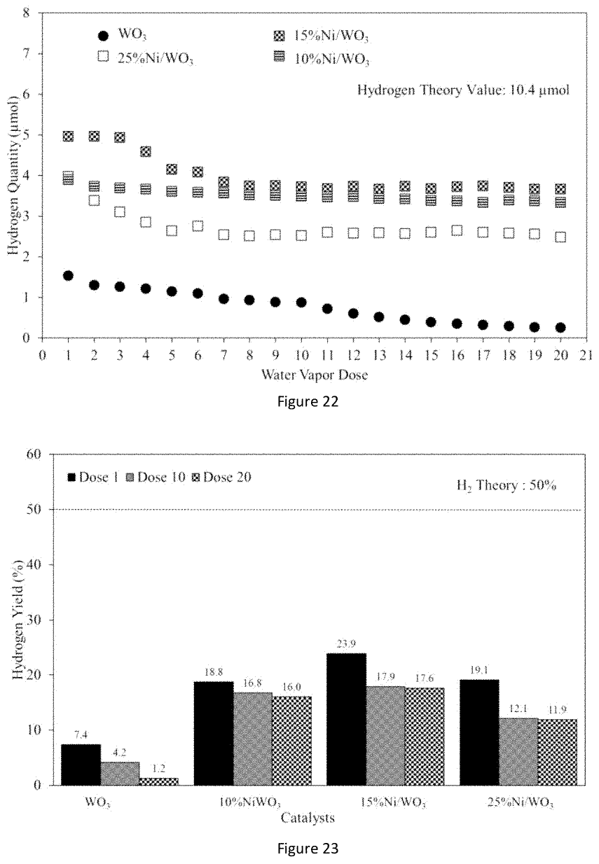

FIG. 22 shows the hydrogen quantity profile of the undoped WO₃ and Ni/WO₃ catalysts. WO₃ has produced low of hydrogen production activity with 1.5 μmol H2 in the first dose and decreases sharply to 0.2 μmol H₂ at the 20th dose. However, 15% Ni/WO₃ catalysts obtained higher hydrogen production respectively (Dose 1=4.9 μmol and Dose 20=3.6 μmol). The increase of hydrogen production quantity for Ni/WO3 catalyst was due to the ability of the catalyst to reduce the WO₃ phase to active phase which able to split water vapour molecule to produce hydrogen as compared to WO₃.

Moreover, FIG. 23 shows the percentage profile of hydrogen yield of Ni/WO₃ catalyst at various Ni loading compared with WO₃. WO₃ catalyst show a very low yield of hydrogen yield (Dose 1=7.4%, Dose 10=4.2%, Dose 20=1.2%). This is due to a deficiency or limited of reduced WO₃ phases that could carry out oxidation (water splitting) reaction to produce hydrogen. As the Ni loading increases, the hydrogen quantity produced increased gradually due to the Ni dopant could enhance the CO adsorption and improve the reduction reaction by producing more active site that able to reacts with water vapour molecule to produce hydrogen. However, the hydrogen yield of 25% Ni/WO₃ displays a significant decrease (Dose 1=19.1%, Dose 10=12.1%, Dose 20=11.9%). This due to the active site has started to be covered with a carbon deposition layer. Therefore, active sites that can react with water vapour are decreasing to produce hydrogen gas.

It can be concluded that 15% Ni/WO₃ was the ideal catalyst to apply the two step reaction that consist of reduction followed by oxidation reaction in order to produce higher hydrogen gas.

### Effect of Reduction Temperature

Effect of reduction temperature were conducted as the reduction temperature is crucial in producing the phases as active sites which responsible to react with water vapour molecule to produce hydrogen. The selected catalyst 15% Ni/WO₃ was performed production of hydrogen at different reduction temperatures of 800° C., 850° C. and 900° C. Whereas the temperature for the oxidation reaction (water splitting) is set at 800° C. During the reaction of water molecules, 20 times of water vapour doses were passed with a nitrogen flow rate carrying water vapour at 20 ml/min.

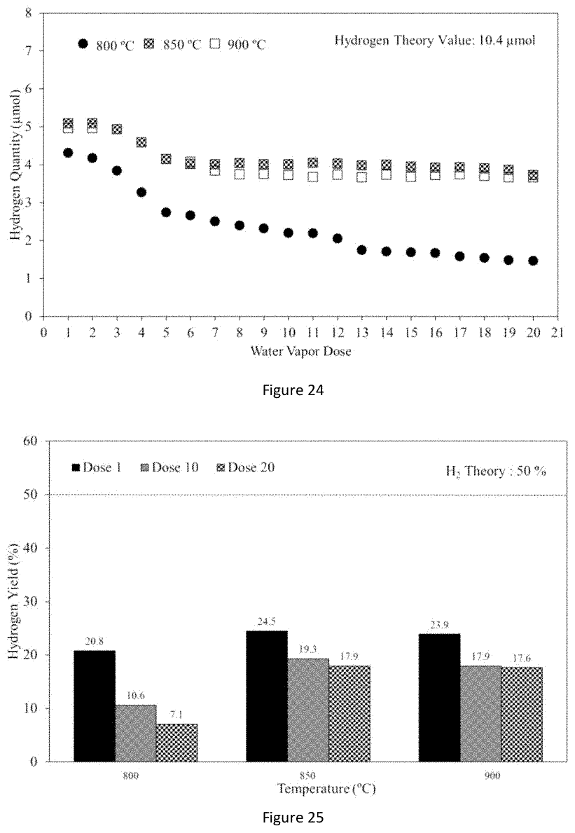

FIG. 24 shows the hydrogen quantity profile for 20 times number of water vapour doses at different reduction temperature. Hydrogen quantity is produced in comparison to hydrogen quantity from theoretically dissociated water molecules (10.4 μmol) based on Equation 5 The results show the hydrogen quantity at 900° C. (Dose 1=4.9 μmol and Dose 20=3.6 μmol). When the descending temperature is reduced to 850° C., hydrogen quantities show a slight increase (Dose 1=5.1 μmol and Dose 20=3.7 μmol) and can be regarded as no significant increase. Furthermore, when the temperature is lowered to 800° C. the quantity shows a sudden drop in the quantity of hydrogen produced (Dose 1=4.3 μmol and Dose 20=1.4 μmol).

The percentage of hydrogen yield in FIG. 25 is based on the percentage of hydrogen yield selection. The percentage of selectivity can be determined based on the theory of water molecular division by using WO₂ in accordance with Equation 5. Oxidation reaction or water splitting by WO₂ to WO₃ metal oxide by producing H₂:WO₂ as 1:1. Therefore, the percentage of hydrogen yield is 50%, while the rest is the oxidized metal oxide that represents WO3. The percentage of yield at 850° C. was (Dose 1=24.4%, Dose 10=19.3% and Dose 20=17.9%). While at the temperature of 800° C. the hydrogen yield decreased sharply (Dose 1=20.8%, Dose 10=10.6% and Dose 20=7.0%).

It can be concluded that, reduction reaction at temperature 800° C. was not suitable for production of hydrogen due to less active sites compared to reaction at temperature 850° C. Therefore, the optimum temperature for reduction reaction was at 850° C. as its lower than 900° C.

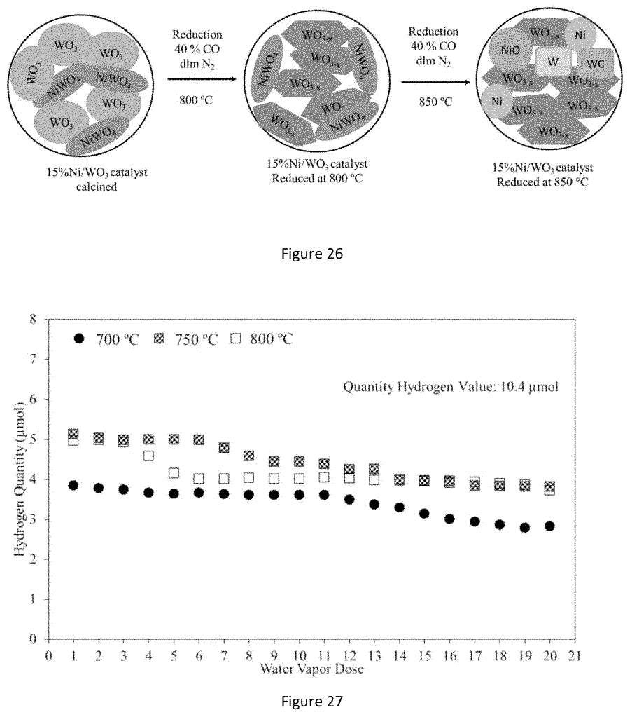

The reduction reaction of 15% Ni/WO₃ catalysts is summarized using proposed illustration in FIG. 26. The diagram shows phase changes that involved in the reduction temperatures of 800° C. and 850° C. After the calcination process at 600° C. for 4 hours, the catalyst was in a mixture compound consisting of WO₃ phase and NiWO4 complex alloy which formed due to reaction between W and Ni. Subsequently, after reduction reaction at 800° C., the WO₃ phase was found reduced to WO₃₋ₓ (WO_{2.72}, WO₂ and W) phases, while the NiWO₄ complex alloy phase was still present and there was no change. When the reaction temperature decreased to a temperature of 850° C., a NiWO₄ alloy compound was reduced to the WO₃₋ₓ of tungsten oxide phase and the Ni compound of NiO and Ni. The WO₃₋ₓ phase is also reduced to W and WC phase. Thus, active sites that comprising reduced tungsten are W, WC and Ni metal produced at 850° C. found to increase the hydrogen production.

### Effect of Oxidation Temperature

The effect of oxidation reaction temperature (water splitting) on hydrogen production is also studied. The optimization of the reduction reaction temperature of the 15% Ni/WO₃ catalyst system was determined at 850° C. based on the results discussed previously. The reaction of water molecules (oxidation) is done at different temperatures of 700° C., 750° C. and 800° C.

FIG. 27 shows the hydrogen quantity profile for 20 times the number of water vapor doses at different temperatures. The oxidation temperature (water molecular diffusion) at 750° C. shows the highest hydrogen quantity with a total of (Dose 1=4.9 μmol and Dose 20=3.6 μmol). While the temperature of 700° C. is too low to break down the molecule, the quantity of hydrogen obtained is seen decreasing as much (Dose 1=3.8 μmol and Dose 20=2.8 μmol).

At the oxidation temperature of 700° C. the percentage of hydrogen yield is (Dose 1=18.5%, Dose 10=17.2% and Dos 20=13.6%). Whereas, when the reaction temperature was increased to 750° C., the percentage of hydrogen yield was 24.7% in first water dose and slightly decreased to 21.4% and 18.4% in the dose of 10th and 20th respectively. At the temperature of 800° C. the percentage of hydrogen is (Dose 1=23.9%, Dose 10=19.3% and Dos 20=17.9%).

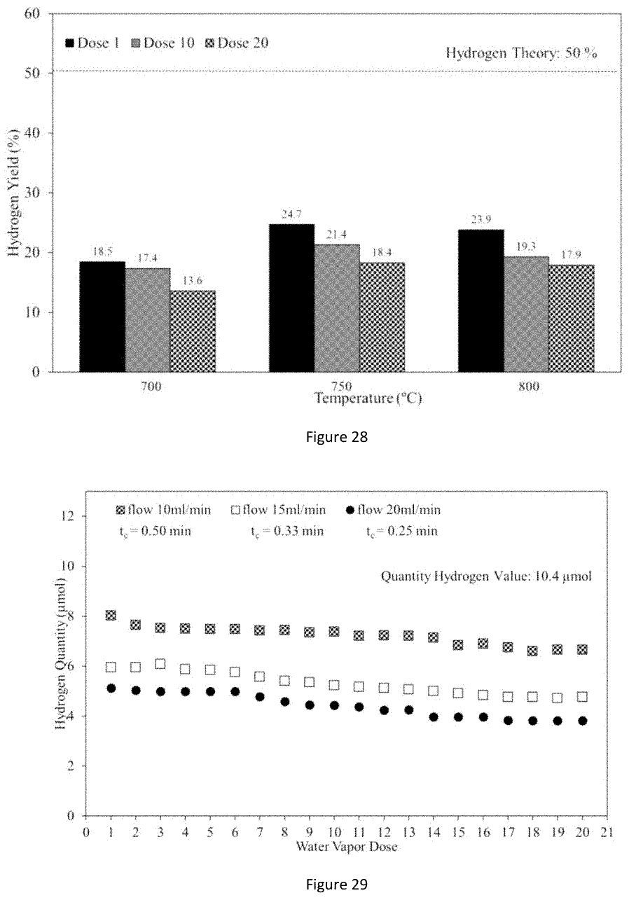

Furthermore, FIG. 28 shows the hydrogen yield at water vapour dose 1, 10 and 20 at varying oxidation temperature. Hydrogen yield obtained at temperature 750° C. does not show a significant difference when compared to the yield at 800° C. Whereas, the temperature of 700° C. is too low for oxidation reaction (water splitting). As a result, temperature at 750° C. was selected to be the optimum parameter for oxidation reaction (water splitting) as less electricity needed compared to at 800° C.

### Effect of Nitrogen Flow

The effect of nitrogen flow rate which carrying water vapour during oxidation reaction was also studied on the production of hydrogen. This optimization uses the best catalyst system of 15% Ni/WO₃ by using the reduction and oxidation temperature of 850° C. and 750° C. respectively based with varying flow rate at 10, 15 and 20 mL/min.

The oxidation reaction of reduced 15% Ni/WO₃ catalyst by using 20 times water vapour dosing. The effect of nitrogen flow rates that carry water vapor on hydrogen production can be identified through contact time calculations as in Equation 7.5. Whereas Table 4 shows the flow rate of nitrogen gas and the contact time of the sample for the production of hydrogen

$$Contact time ( min ) {t}_{c} = Catalyst volume ( ml ) / Flow rate {N}_{2} ( ml \text{/} min ) \\ Where , catalyst volume = 5 ml \qquad ( Equation 11 )$$

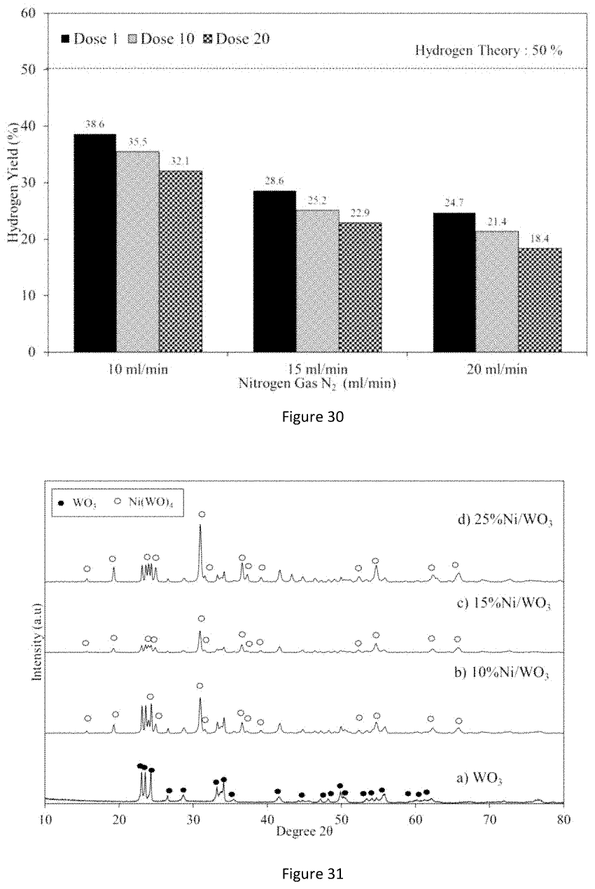

FIG. 29 and FIG. 30 show the hydrogen quantity and hydrogen yield profile for 20 times water vapour dosing for varying nitrogen gas flow rate which carries water vapour at 10, 15 and 20 ml/min. At a flow of 10 ml/min, the hydrogen quantity produced at the first dose was 8.0 μmol H₂ and decreased at the 20th dose of 6.6 μmol H₂. Whereas when the nitrogen flow was increased to 15 ml min, the resulting hydrogen showed a decrease of 5.9 μmol H₂ and 4.7 μmol H₂ respectively at the first and 20th water vapour dose respectively. The quantity and yield of hydrogen showed a significant decrease when the N₂ gas flow rate increased at 20 ml/min with the hydrogen quantity at the first water vapor dose of 5.1 μmol H₂ and decreased at the 20th dose of 3.8 μmol H₂. This increase is very significant, almost twice the amount of hydrogen obtained compared to the water vapour flow at 20 ml/min.

It can be concluded that slowly the water vapour pass through, higher the percentage of water vapour conversion to hydrogen. This is because the longer the water vapour is exposed to the active site (contact time) of the sample, the higher the probability of reaction that could occur than if it were carried out in relatively in short periods. Therefore, the water vapour flow at 10 ml/min was the optimum parameter to produce optimum hydrogen for the reactor used.

TABLE 4
Nitrogen flow rate carriers water vapour against contact time

| Nitrogen Flow Rate | Catalyst volume | Contact time |
|---|---|---|
| (ml/min) | (ml) | (min), t_{c} |
| 10 | 5 | 0.50 |
| 15 | 5 | 0.30 |
| 20 | 5 | 0.25 |

### Crystallinity of Catalyst by Using XRD Technique

XRD pattern of as prepared undoped WO₃ and nickel doped WO₃ at different loading (10, 15 and 25 wt %) obtained after calcination at 600° C. are shown in FIG. 31. All peaks in the diffraction pattern of undoped WO₃ were assigned to stoichiometric monoclinic phase (JCPDS 1-072-0677). Small changes were observed with respect to the presence of complex alloy NiWO4 (JCPDS-1-072-1189) after addition of Ni element due to the chemical interaction between nickel nitrate with tungsten oxide. As a result, Ni/WO₃ catalyst consisting of two species WO₃ and NiWO₄. Moreover, the intensity of monoclinic WO₃ phase reduces as the Ni loading added increases.

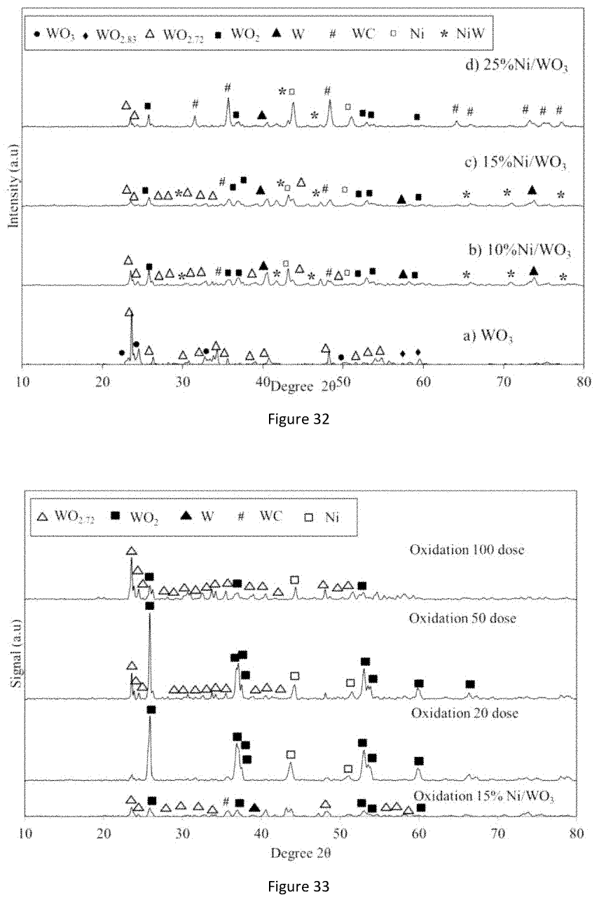

Analysis of the crystalline properties of undoped WO₃ and Ni/WO₃ catalyst with different Ni loading catalysts were performed to determine the phase transformation. XRD diffractogram within the range of 20 between 100-800 for the reduced catalyst shown in FIG. 32. The XRD diffraction pattern for undoped WO₃ showed small changes, in which the WO3 has been partially reduced to the suboxide WO2.83 (JCPDS 45-0167) and with monoclinic WO_{2.72} phases with remaining WO₃ (JCPDS 1-072-0677) were still not completely reduced.

However, when 10% Ni is added, the WO₃ phase completely disappered and transformed to be W cubic phase (JCPDS 4-0806), NiW monoclinic phase (JCPDS 01-0722-2653) and Ni phase (JCPDS 1-077-3085) monoclinic. The catalyst 15% Ni/WO₃ also gives the similar phase changes with 10% Ni/WO₃ catalyst. Whereas the 25% Ni/WO₃ catalyst after the reduction reaction showed the intensity of the WC phase (JCPDS 1-073-9874) and Ni metal phase was found to increase compared to 10% Ni/WO₃ and 15% Ni/WO₃ catalyst. In addition, the Ni metal phase is also more visible than the lower loading of Ni element as well as the intermediate phase of the metal (intermatallics) NiW. According to the thermodynamic calculation of reduction of WO3 and NiO by CO, NiO is likely to be reduced at lower temperature than WO₃. This phenomenon has been proven by the previous study that the occurrence of a phase transformation initiated with a reduction of (NiO→Ni), (WO₃→WO₃₋ₓ and WC) and (NiWO₄→WO₃₋ₓ, NiO and Ni) as reported by (Ahmed and Seetharaman 2010).

Furthermore, it is also reported that the sample weight also increases when the WC begins to form due to the occurrence of carbon deposition (Mohammadzadeh et al. 2014). It clearly shown that, when the percentage of Ni loading increases, the temperature of the WO₃ reduction reaction is shifted to the lower temperatures. This is due to the catalytic effect of Ni which increases CO adsorption and its effect can improve the reduction reaction ability.

The analysis of the crystalline catalyst properties of 15% Ni/WO₃ for the optimum condition of the optimum reduction of 850° C. and the oxidation reaction condition at 750° C. was reported. XRD diffractograms in the range 2θ between 10-800 for after the reduction and oxidation reactions for 20, 50 and 100 times of the dosage of water vapour are shown in FIG. 33 The XRD diffraction pattern for subsequent reductions showed that the formation of the suboxide phase WO2.72 (JCPDS 1-073-2177) was the most dominant monocline. While the monocline phase WO2 (JCPDS 32-1393) is also appeared. Whereas the relatively low peak exists for phase W (JCPDS 4-0806) and WC phase (JCPDS 1-073-9874). Meanwhile, the Ni phase (JCPDS 1-077-3085) was also formed as a result of the NiO reduction, while the intermetallic NiW (JCPDS 47-1172) was formed as a result of the reduction of the NiWO4 alloy complex formed during the calcination process.

Nevertheless, the diffraction pattern after oxidation reaction (water splitting) for 20 times water vapour dose observed phase of WO2 (JCPDS 32-1393), suboxide WO2.72 (JCPDS 1-073-2177) and Ni metal (JCPDS 1-077-3085). However, WC phase and W metal phase have disappeared completely. This is probably due to the fact that the phase has completely oxidized it to form the WO₂ phase. It matches with the peak intensity of the WO₂ phase is increasing. While the number of doses of water vapour is extended to 50 times, the diffraction pattern shows small changes. Where the peak of the suboxide phase becomes obvious. This is because more phases are oxidized to phase WO₂. When the oxidation reaction (water splitting) is done 100 times, the XRD pattern shows the intensity of WO₂ phase decreases as it has been oxidized to the suboxide phase WO_{2.72}. However, the Ni metal phase formed after the reduction reaction still exists even after 100 times dosing with water vapour. It shows that Ni element is not involved in the oxidation process to produce hydrogen gas.

### Morphology Analysis by Using FESEM

FIG. 34 (i), (ii) and (iii) shows the FESEM image of WO₃, NiO and 15% Ni/WO₃ catalysts as seen in magnification 20,000 of after being coated at the same temperature and time at 600° C. for 4 hours respectively. WO₃ morphology which had structures such of polyhedral particles with non-uniform size and have smooth surfaces (Hongbo et al. 2015). Whereas, NiO has no particular geometric shapes, but is shaped like cubic or semi-small spherical grain (Rashidi, Ebrahim, and Dabir 2013). While, the WO₃ morphology changes due to the existence of a new NiWO₄ alloy particle complex after the calcination process for 15% Ni/WO₃, The morphology looks like two types of spheres representing WO₃ metal oxide, while the non-uniform spherical-sized represents NiWO4 alloy complexes and little NiO morphology with a small partial sphera.

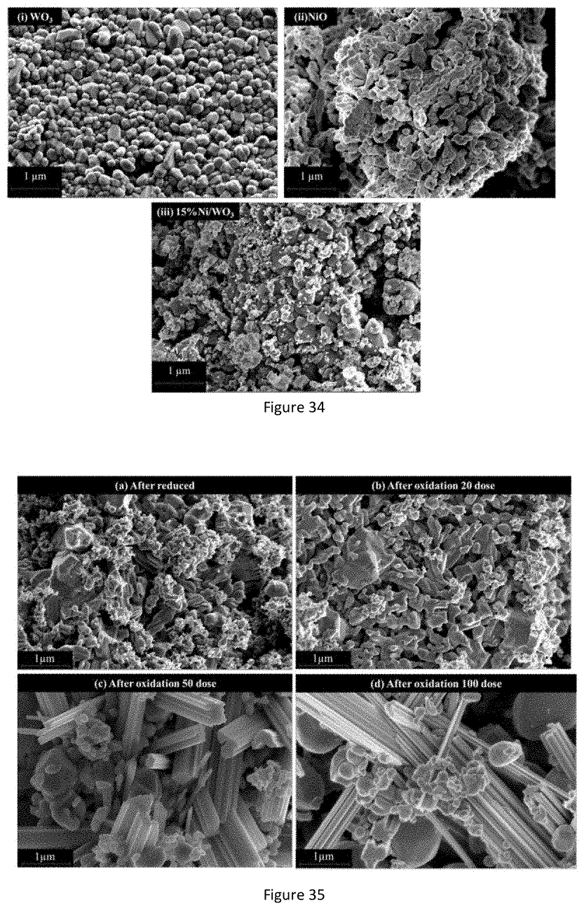

Furthermore, FIG. 35 (a-d) shows the image of the catalyst FESEM of 15% Ni/WO3 after the reduction and oxidation reaction. FIG. 35 (a) shows the changes in the morphology formed after the reduction reaction before the oxidation reaction is carried out. Clearly visible phase WO_{2.72} which has a morphology such as a combination of needles, WO₂ phase observed with rossettes shape resembling an agglomeration of spherical and the rough cubes pattern assigned to the W phase. This morphology was matched with the results obtained from XRD analysis.

Meanwhile, FIG. 35 (b) shows the morphology of after oxidation reaction (water splitting) after 20 times number of water vapour doses. It is expected that the WO₂ phase will change to WO_{2.72} phase corresponding to the XRD results where the intensity of WO₂ decreases relative after the reduction reaction and it is in agreement with the morphological changes obtained.

Furthermore, the morphology after oxidation reaction using the number of doses of water vapour 50 times indicates that the size is increasing as shown in FIG. 35 (c). There can be seen three forms that describe three clear phases it appears that the WO_{2.72} suboxide phase with structural looks like needles is very clear compared to the previous picture. While the small spherical shape is expected from the NiO phase is also visible and the large sphere structure resembling of W phase. Structure of needles and small spheres obviously obtained after the reaction of water molecules with 100 times of water vapour dose as shown in FIG. 35 (d). in addition, the morphology achieved by FESEM analysis were in an agreement with the XRD analysis.

### Summary Tungsten Oxide Catalyst

Catalyst: 15% Ni/WO₃
The following optimum experimental conditions were employed tungsten oxide during reduction and re-oxidation

TABLE 5
Optimum experimental conditions (tungsten oxide) during
reduction and re-oxidation

| Operating Parameter | Condition |
|---|---|
| Step 1: | |
| Reduction Temperature (° C.) | 850 |
| Concentration CO in Nitrogen (CO in N₂) | 40 |
| (%) | |
| Flow rate of CO gas (mL/min) | 20 |
| Step 2: | |
| Oxidation Temperature (° C.) | 750 |
| Flow rate nitrogen carrier (mL/min) | 10 |

Active sites/active phase:

The optimum reduction reaction of catalyst 15% Ni/WO₃ is at 850° C. by producing suboxide phase WO_{2.72}, WO₂, W, and WC.

TABLE 6
Catalyst activity

| Performance | Dose 1 | Dose 20 |
|---|---|---|
| Hydrogen quantity (μmol) | 8.0 | 6.6 |
| Hydrogen yield (%) | 38.6 | 32.1 |

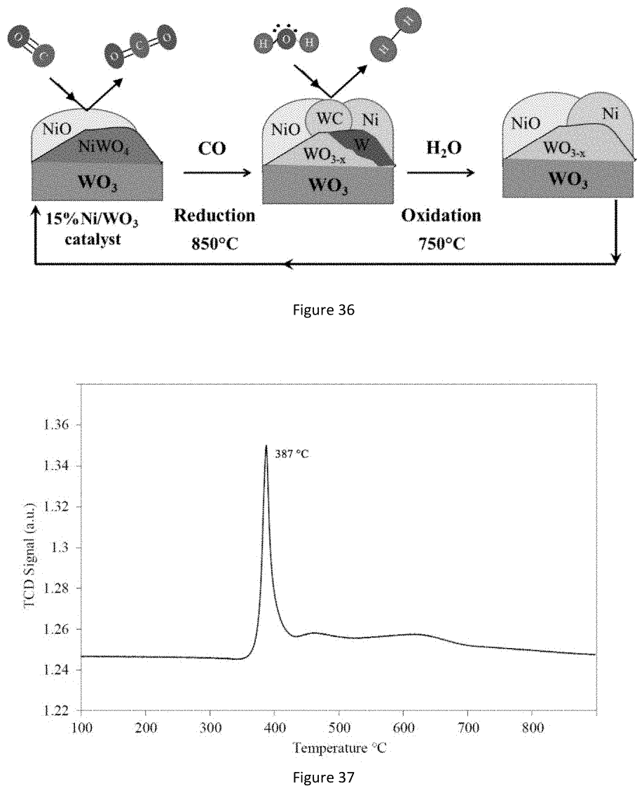

Proposed phases transformation in production of hydrogen via redox reaction using 15% Ni/WO₃ is showed in FIG. 36.

### Example 3

### Nickel Oxide Catalyst

Nickel oxide was used as well-established catalyst due to its surface oxidation properties (Rahim, Hameed, and Khalil 2004). It is known that catalysis is a surface effect which the catalyst use needs to have the highest possible active surface area (Antolini 2003). The reduction of metallic oxides to the metal has been extensively studied because it represents a class of heterogeneous reactions which are of considerable technological and commercial importance (Ostyn and Carter 1982). Doping methods have been extensively utilized to modify the electronic structures of nanoparticles to achieve new or improved catalytic, electro-optical, magnetic, chemical, and physical properties (Liao et al. 2008). The reduction of undoped and doped NiO catalysts has been studied extensively and plays an important role in many catalytic reactions (Laosiripojana 2005). The main applications of nickel oxide, such as catalysis (Kuhlenbeck, Shaikhutdinov, and Freund 2013), batteries (Poizot et al. 2000), supercapacitors, electrochromics (Gillaspie, Tenent, and Dillon 2010), sensors (Hoa and El-safty 2011) and many others can often benefit from nano structuring and from reducing the crystal size down to the nanometer scale.

Similar to other transition metal catalysts, the NiO catalyst requires reduction to give active phase (i.e. metallic Ni) prior to their use. In industry, the catalyst reduction is usually conducted with either hydrogen-containing gases or natural gas-steam mixtures. Reduction conditions are important as they have influences on subsequent catalytic activity. For instance, high temperatures and rapid reduction may result in lower Ni dispersions and less activity, the introduction of carbon or sulphur may accelerate catalyst deactivation (Sehested 2006; Valle et al. 2014). Therefore, in this studies Ni had been chosen as a catalyst for H2 production and studies of its chemical properties after regeneration.

### Reduction Properties of Catalyst by Using CO-TPR Technique

FIG. 37 shows Carbon Monoxide-Temperature Programme Reduction (CO-TPR) profile for NiO catalyst reduction analysis to form Ni metal by non-isothermal treatment until temperature reached to 900° C. with flow rate 10° C.·min⁻¹ under flow 20 mL·min⁻¹ of 40% CO in N₂. Based on the CO-TPR profile, only one sharp peak was observed with sign I. This peak showed reduction reaction NiO to Ni(0) is starting to occur at temperature 387° C. but only partially is reduced because of at this temperature Boudouard also occurred. The reduction of NiO catalyst with CO and Boudouard reaction is shown at below equation (Equation 12 and Equation 13). The Boudouard reaction was likely to occur spontaneous with the present of excess CO and maximum due to value of enthalpy reaction, ΔHr=−172.0 kJ·mol⁻¹ was very negative. Compared to reduction reaction for NiO catalyst the enthalpy reaction, ΔHr=−43.0 kJ·mol−1 was less negative so the reaction occurred only partially.

$$\begin{matrix}2 CO ( g ) {CO}_{2} ( g ) + C ( s ) \\ ( Δ Hr = - 1 \; 72.0 kJ \cdot {mol}^{- 1} ; Δ S r = - 0.1 \; 763 J \cdot {mol}^{- 1} {K}^{- 1} dan T ( Δ G = 0 ) = 97 {6}^{∘} C . ) & ( Equation 12 ) \\ NiO ( s ) + CO ( g ) \to Ni ( s ) + CO 2 ( g ) \\ ( ΔHr = - 4 \; 3.0 kJ \cdot mol - 1 ; ΔS r = + 0.008 J \cdot mol - 1 K - 1 dan T ( ΔG = 0 ) = - {5102}^{∘} C . ) & ( Equation 13 )\end{matrix}$$

### Production of Hydrogen

### a. Effect of Support Material for Nickel Oxide

Supporting materials work as a clutter site and stabilizer for active compound such as metals and metal oxides. The use of active substances is to prevent from only elements or clusters of surface-exposed elements to react in the catalysis process. Additionally, this supporter can also prevent active compound from clumping. In general, the supporting material is inert so it will not engage in ongoing reactions, it can even contribute to increasing catalytic activity. Based on previous studies, the use of supporting materials can have a very significant effect on its catalytic activity in the reduction reaction of metal oxide and oxidation reaction (water splitting). Typically, the supporting materials used include SiO₂, Al₂O₃, TiO₂ and ZrO₂. In this study, support materials used such as Al₂O₃ (K) and Al₂O₃ (A) are more neutral while SiO₂ and SiO₂—Al₂O₃ are slightly acidic.

Oxidation reaction (water splitting) is carried out on a NiO supported catalyst to test the activity of this catalyst in hydrogen production activity. All the NiO supported catalysts that have undergo the reduction reaction at temperature 700° C., then carry out the reaction with water vapor in the oxidation reaction (water splitting) for the production of hydrogen using a chemical vapor pulse technique of water at 600° C. All catalysts demonstrate the ability to produce hydrogen but provide different quantities of yield. The quantity of hydrogen using all supported catalysts shows the pattern or descending order according to the catalysts as follows: 5% NiO—SiO₂>5% NiO—Al₂O₃ (K)>5% NiO—Al₂O₃ (A)>5% NiO—SiO₂—Al₂O₃.

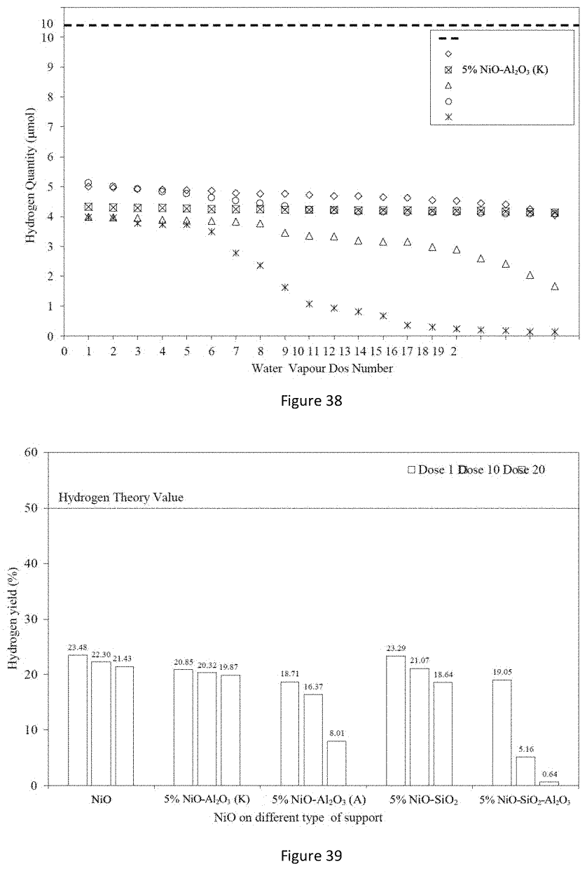

FIG. 38 shows the highest hydrogen quantity of 5% NiO—SiO₂ compared to the other catalysts of 4.84 μmol at the first dose of water vapour and decreased to 3.88 μmol at dose of 20 water vapour. This may be due to the increase in the number of active sites on the surface of the 5% NiO—SiO₂ catalyst, thereby further promoting hydrogen production. Whereas, the quantity of hydrogen produced by NiO catalysts supported by Al₂O₃ (K) showed a slightly lower percentage compare to SiO₂ of 4.34 μmol in the first dose of water vapour and decreased up to 4.13 μmol 20th dose of water vapour. Nevertheless, the percentage of hydrogen quantities produced by NiO catalysts supported by Al₂O₃(A) and SiO₂—Al₂O₃ showed a significantly lower of 3.89 μmol and 3.96 μmol respectively at the first dose of vapour water and decreased to 1.67 μmol and 0.13 μmol at the dose of 20 water vapour. The decrease in quantity of hydrogen is likely due to the decreasing of active site.

FIG. 39 shows the percentage profiles of hydrogen yields for the first, 10th and 20th water vapour dose for reduced NiO catalysts supported. The percentage of hydrogen yield of NiO catalysts supported by Al₂O₃ (A) and SiO₂—Al₂O₃ shows a lower percentage of hydrogen yield compared to NiO catalyst without supporting material ie 18.71% and 19.05% respectively in the first dose of water vapour and subsequently decreased dramatically on the dose of vapour 10th water and 20th water vapour dose (8.01% and 0.64%). Nevertheless, the percentages of hydrogen yield of NiO catalysts supported by Al₂O₃ (K) and SiO₂ record the percentage of hydrogen yield which is almost equivalent to NiO catalyst without support (first dose=23.48%; 20th dose=21.43%) ie 20.85% and 23.29% in first dose and at dose 20 decreased slightly to 19.87% and 18.64% respectively. Although the addition of only 5% wt. NiO load on support materials but hydrogen percentages are almost equivalent to NiO without support materials. Equivalent percentages of hydrogen yield between NiO without supporters, 5% NiO—Al₂O₃ (K) and 5% NiO—SiO₂ may be due to the number of active sites that increase evenly on the surface of the support material.

As a conclusion, the 5% NiO—SiO₂ was choosen as the best catalyst for hydrogen production for Ni based catalyst.

### b. Effect of Reduction Temperature

For optimum temperature reduction reaction effect using 5% NiO—SiO₂ catalyst was performed at four different temperatures of 500° C., 600° C., 700° C. and 800° C. Whereas the temperature of the oxidation reaction (water splitting) is set at 600° C. Water vapour dosage of 20 times during oxidation reaction (water splitting) with nitrogen flow carrying water vapour at 20 mL·min⁻¹.

Among the factors that can influence the production of hydrogen at the optimum level are the different in reduction temperature. Thus, the reduced 5% NiO—SiO₂ catalyst in hydrogen production analysis purposely to study the effect of different reduction temperature on hydrogen production. The Pulse Chemisorption Water Vapour (PCWV) techniques was used for the oxidation reaction with temperature (water splitting) 700° C. with a 0.23 cm² (10.40 μmol) dose of water vapour with a flow rate of N₂ which carries a water vapour was 20 mL·min⁻¹. However, before the oxidation reaction (water splitting) is carried out, 20 mL·min⁻¹ N₂ gas is allowed to flow for 30 minutes to ensure that the CO trapped during the reduced reaction is eliminated.

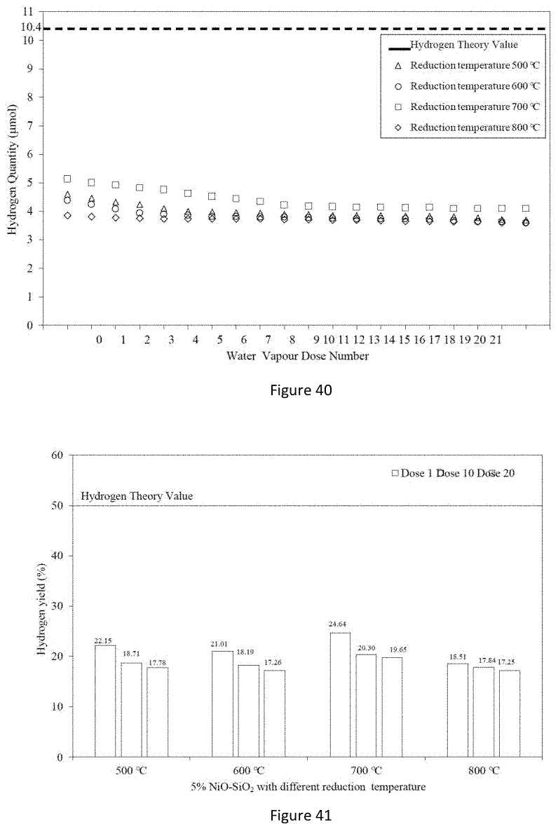

FIG. 40 shows the hydrogen quantity profile at different reduction temperature. Based on the profile, non-isothermal reduction to 800° C. show the lowest hydrogen quantity of only 3.85 μmol in the first water vapour dose and 3.59 μmol in the 20th water vapour dose. This percentage decrease was due to the sintering of NiO catalyst supported on SiO₂ at high temperatures. This sintered causes the catalyst to form a lump which in turn reduces the number of active sites in the oxidation reaction (water splitting) for the production of hydrogen. Non-isothermal reduction to 600° C. and 500° C. temperatures were almost equivalent to 800° C. of 4.37 μmol and 4.61 μmol respectively at the first water vapour dosage and 3.59 μmol and 3.70 μmol respectively the 20th water vapour dosage. The reduction in the hydrogen quantity was probably due to the presence of NiO phases that existed in amorphous conditions which were not completely reduced to the Ni phase after the reduction reaction. Meanwhile, non-isothermal reduction temperature at 700° C. was significantly higher in the first water vapour dosage of 5.12 μmol and 4.09 μmol compared to other temperatures. This percentage increase is due to NiO catalyst completely reduced to Ni phase at this temperature.

Determining the percent yield of hydrogen is determined with regard to the selectivity of hydrogen yield by 50%. Theoretically the percentage of hydrogen yield (% yield=% conversion×optimum) maximum is 50%. FIG. 41 shows the percentages of hydrogen yield for non-isothermal reduction at temperature 700° C. is able to produce the highest hydrogen yield percentage of 24.64% in the first water vapour dose and 19.65% in the 20th water vapour dose compared to three other reduction temperature. This is due to the NiO phase was fully reduced to the Ni phase which allows the active site of Ni phase to react with water molecules to produce optimum hydrogen. Non-isothermal reduction at temperature 500° C. and 600° C. decreased the hydrogen yield by 22.15% and 21.01 respectively in the first water vapour dose and 17.78% and 17.26% respectively in the 20th water vapour dose respectively. This percentage hydrogen yield decreased may be due to the absence of fully NiO phase into the Ni phase. Whereas at a reduction temperature of 800° C. shows the lowest percentage of hydrogen yield was 18.51% in the first water vapour dose and 17.25% in the 20th water vapour dose. The decreasing in the percentage of hydrogen results is related to the occurrence of sintering which reduces the active site for oxidation reaction (water splitting).

In the effect of reduction temperature to 5% NiO—SiO₂ catalyst shows that the suitable temperature for reduction temperature to produce optimum hydrogen was 700° C.

### Effect of Oxidation Temperature

In addition to the effects of reduced temperature being taken into account for the most optimum hydrogen yield, the effect of oxidation temperature is also being taken into account and also studied in this research. Oxidation reaction (water splitting) is performed at different temperatures of 500° C., 600° C., 700° C. and 800° C. with water vapour as much as 20 times of the dose. Water vapour of 0.23 cm3 (10.4 μmol H₂O) is flushed for each dose.

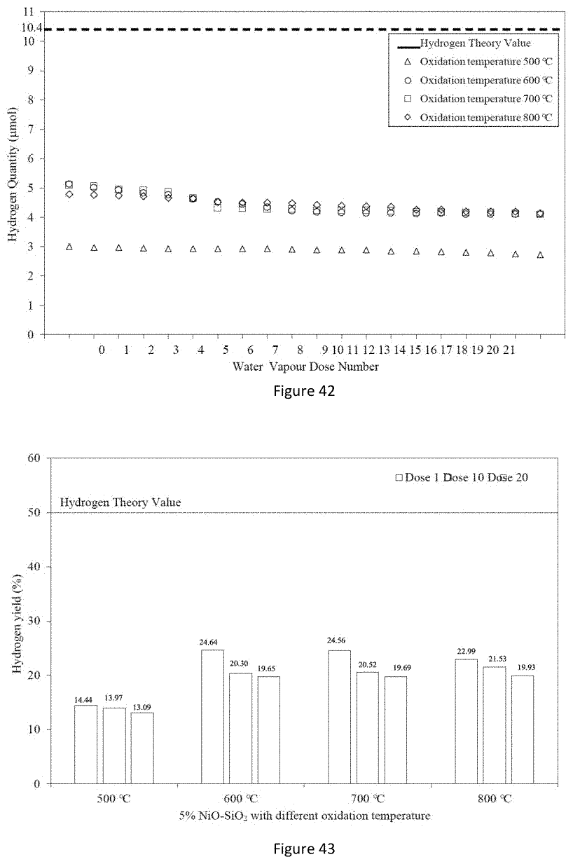

The resulting hydrogen quantity profile is shown in FIG. 42. Based on the profile obtained, as the temperature of the oxidation reaction rise, contributes to the higher production of hydrogen. The result of the analysis, the decreasing sequence of the percentage of hydrogen quantity at the oxidation reaction temperature (water splitting) is as follows: 600° C. (5.12 μmol)>700° C. (5.11 μmol)>800° C. (4.78 μmol)>500° C. (3.00 μmol) at first water vapour dose and 600° C. (4.09 μmol)>700° C. (4.10 μmol)>800° C. (4.15 μmol)>500° C. (2.72 μmol) at the 20th water vapour dose. The hydrogen quantity decreases when the oxidation reaction temperature (water splitting) increases due to the occurrence of NiO catalysts or sintering which in turn reduces the number of active sites for hydrogen production. For oxidation reaction (water splitting) temperature 500° C. gives the lowest percentage of water vapour conversion due to low temperature violation rate of the molecule is very slow and less active. However, the production of hydrogen at temperatures of 600° C., 700° C. and 800° C. shows almost same pattern of hydrogen production. Because hydrogen production is almost the same for all three temperatures, the most suitable temperature is 600° C.

Meanwhile, FIG. 43 shows a percentage of the hydrogen yield profile at four different oxidation reactions (water splitting) of 500° C., 600° C., 700° C. and 800° C. Percentage of hydrogen production is determined by taking into account the percentage of ownership to 50% hydrogen. It can be seen that the highest percentage of hydrogen yield is shown at the temperature of oxidation reaction (water splitting) 600° C. which is 24.64% at first water vapour dose and 19.65% at dose 20. While the lowest percentage of hydrogen yield was recorded at the oxidation reaction temperature (water splitting) 500° C. at 14.44% at the first water vapour dose and 13.09% at the 20th water vapour dose. The results show that the percentage of yield decreases when the oxidation reaction temperature (water splitting) decreases. Therefore, the optimum temperature for the oxidation reaction (water splitting) for the production of hydrogen using the reduced 5% NiO—SiO₂ catalyst is at 600° C.

### Effect of Nitrogen Flow as Water Vapour Carrier

In addition to the effect of the temperature reduction reaction and the temperature of the oxidation reaction (water splitting), the effect of the N₂ flow rate or contact time which carries the water vapour for oxidation reaction (water splitting) also plays a very important role in the production of hydrogen. This is because, the flow rate of N₂ which carries a slower vapour of water will give a longer time to reaction between water molecules with catalytic surface contact and thus will give more hydrogen results. In order to study the effect of N₂ flows that carry water vapour on hydrogen production, 5% NiO—SiO₂ catalysts are first passed non-isothermal until temperature is 700° C. under 40% CO in N₂ (20 mL·min⁻¹). Furthermore, the oxidation reaction (water splitting) for the production of hydrogen is carried out at 600° C. using a Pulse Chemisorption Water Vapour (PCWV) technique by giving a total of 10.40 μmol of water vapour at each dose with a flow rate of N2 which carries a different water vapour of 20 mL·min−1, 15 mL·min−1 and 10 mL·min⁻¹. However, before the oxidation reaction (water splitting), a total of 20 mL·min⁻¹ N₂ gas was first introduced for 30 minutes to get rid of the CO gas that was trapped during the reducing reaction.

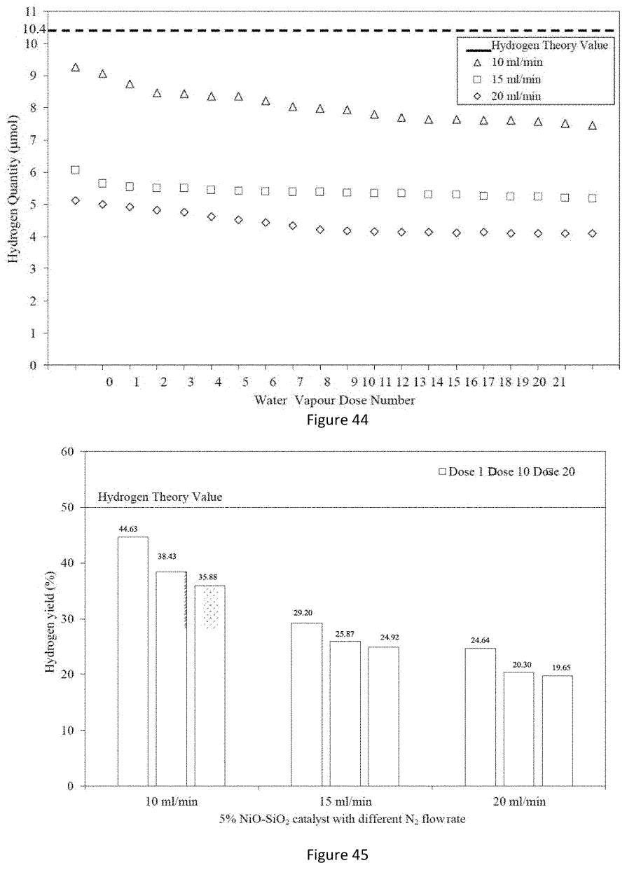

FIG. 44 shows hydrogen quantity profile at N₂ flow rate which carries different water vapour ie 10 mL·min−1, 15 mL·min−1 and 20 mL·min⁻¹. As a result, there was an increase in the quantity of hydrogen produced when the flow rate of N₂ which brought water vapor for oxidation reaction (water splitting) was lowered from 20 mL·min−1 to 15 mL·min−1 and 10 mL·min⁻¹. The quantity of hydrogen at a flow rate of 20 mL·min⁻¹ was 5.12 μmol at the first water vapour dose and decreased to 4.09 μmol at the 20th water vapour dose. Whereas, the decrease in N₂ flow rate which brings water vapour to 15 mL·min⁻¹ clearly shows an increase in the hydrogen quantity of 6.07 μmol in the first water vapour dose and 5.18 μmol in the 20th water vapour dose. Meanwhile, the reduction of N₂ flow rate which brought water vapour to 10 mL·min⁻¹ showed a significant increase in the hydrogen quantity of 9.28 μmol in the first water vapour dose and 7.46 μmol in the 20th water vapour dose. Each dose is injected by 10.40 μmol of water vapour in theory. Therefore, theoretically the quantity of hydrogen produced by oxidation reaction (water splitting) is 10.40 μmol per dose of water vapour. Reducing the flow rate of N₂ that carries this water vapour allows the oxidation reaction (water splitting) between catalysts and water molecules to occur within a longer range of contact time. Hence, the production of hydrogen through oxidation (water splitting) can be increased and closer to hydrogen quantity theoretically.

Meanwhile, FIG. 45 shows the percentage of hydrogen yield for the first water vapour dosage, the 10th and 20th water vapour for 5% NiO—SiO₂ catalyst at N₂ flow rate which carry different water vapour ie 10 mL·min−1, 15 mL·min−1 and 20 mL·min⁻¹. N₂ flow rates that carry different water vapour are determined based on hydrogen yields of 50% percent of hydrogen yield per dose of water vapour. From the resulting profile, the N₂ flow rate carrying water vapour at 10 mL·min⁻¹ was able to provide the highest hydrogen yield percentage of 44.63% in the first water vapour dose and reduced to 35.88% in the 20th water vapour dose. The percentage of hydrogen yield at this water vapour dose is only less than 5.37% of the percentage of theoretical results. Whereas, N₂ flow rate carrying water vapour 15 mL·min⁻¹ shows a high percentage of hydrogen yield compared to the N₂ flow rate which carries 20 mL·min−1 water vapour at 29.20% on the first water vapour dose and decreased to 24.92% at the 20th water vapour dose. This percentage decline is due to most oxidized catalyses during the occurrence of oxidation reaction (water splitting) and the time taken to react too fast. Hence, the flow rate of N₂ that carries 10 mL·min−1 water vapour is selected as it is expected to provide optimum hydrogen yield.

### Crystallinity of Catalyst by Using XRD Technique

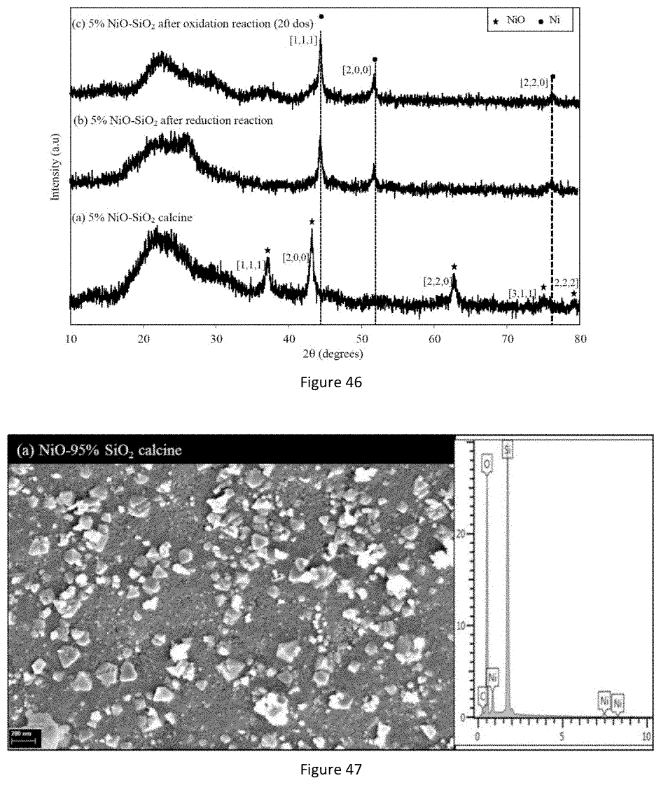

FIG. 46 shows the XRD diffractogramme of 5% NiO—SiO₂ catalyst before and after the non-isothermic reduction reaction up to 700° C. (10° C.·min⁻¹) under the 40% CO flow in N₂ (20 mL·min⁻¹) and after the action oxidation reaction (water splitting) for 20 times dosage of water vapour for hydrogen production at 600° C. with a flow rate of N₂ which carries a water vapour of 10 mL·min⁻¹. In general, the XRD diffraction pattern within the range 26=10°-80° shows the same diffusion peaks for the 5% NiO—SiO₂ catalyzed after the reduction reaction and after the oxidation reaction (water splitting) for the production of hydrogen. The XRD diffraction pattern before the reduction reaction indicates the formation of NiO cube-phase (JCPDS 00-047-1049) on the plane hkl [1,1,1], [2,0,0], [2,2,0], [3,1,1] and [2,2,2]. Furthermore, the XRD diffusion pattern after the reduction reaction and after the oxidation reaction of 20 times and 100 times the amount of water vapor indicated the presence of Ni cubic phase (JCPDS 01-087-9414) in the plane of hkl [1,1,1], [2, 0,0] and [2,2,0] and the diffusion peak for NiO is not visible. Apart from both NiO and Ni peaks, there are other peaks referring to SiO₂ supporters in amorphous conditions that have not undergone any changes before and after the reduction reaction and oxidation reaction (water splitting). This indicates that the SiO₂ support material is inert and does not participate in any reaction.

### Morphology Analysis by Using FESEM

The catalytic characterization using the FESEM-EDX technique was performed against the 5% NiO—SiO₂ catalyst before the reduction reaction is shown in FIG. 47 The method of characterization of this catalyst is used to determine the surface morphology of the catalyst. Meanwhile, the Absorption X-Ray (EDX) technique is used to determine the element on the surface of each catalyst 5% NiO—SiO₂. Morphological analysis indicates that the SiO₂ support material is seen in the amorphous phase and only NiO catalyst particles in various forms appear to be scattered on the surface of SiO₂ support material.

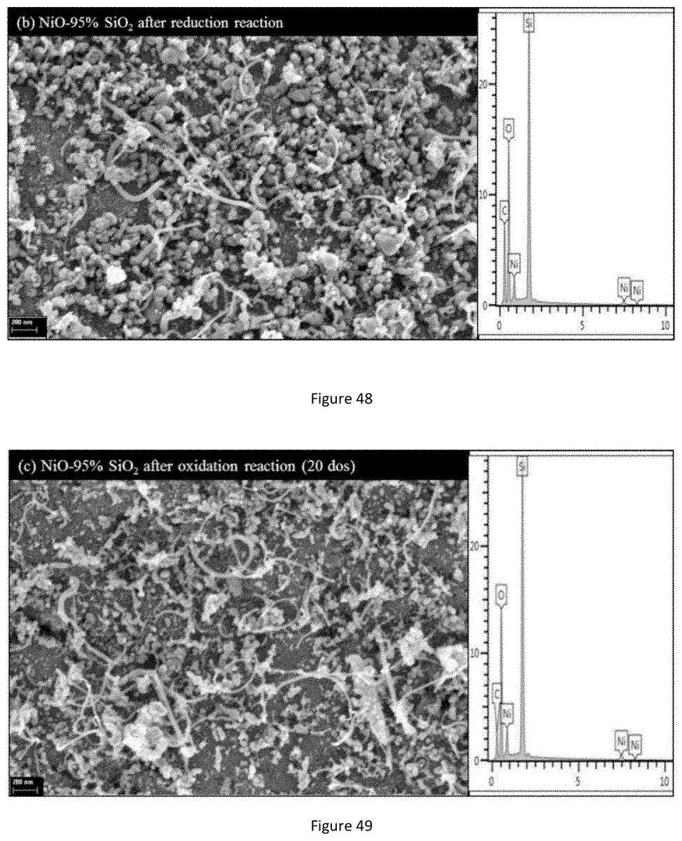

FIG. 48 shows the surface morphology of the 5% NiO—SiO₂ catalyst after a non-isothermic reaction up to 700° C. (10° C.·min⁻¹) with the presence of 40% CO as a reducing agent. The FESEM morphological analysis shows the more unstructured formation of the Ni elements and the projections of element C in carbon nanotube.

The carbon nanotube formation by Ni-based catalysts is widely reported by previous researchers only differing in terms of carbon sources (methane, acetylene, carbon dioxide and carbon monoxide) (Qian et al. 2004) the methods used (arc discharge, laser ablation, chemical vapour deposition, hydrothermal and electrolysis) (Mubarak et al. 2014; Liu et al. 2014; Liu et al. 2014) Whereas, the surface structure of the SiO₂ proprietary material does not show any change after the descending reaction proving SiO₂ supporters do not participate in the reduction reaction with the presence of 40% CO gas.

FIG. 49 shows the surface morphology of reduced 5% NiO—SiO₂ after the oxidation reaction (water splitting) at 600° C. for 20 times the water vapor dose with N₂ flow rate which carried 10 mL·min−1 water vapor. The FESEM image exhibits a somewhat fibrous surface morphology with uneven carbon nanotube projections and Ni particles. There is a slightly decrease in Ni's number of particles and carbon nanotube projections. This occurs because Ni's particles react with oxygen molecules to form NiO again. While element C is likely to react with oxygen molecules to form CO again.

### Summary of Nickel Oxide Catalyst

TABLE 7
Optimum operating parameter for production
of hydrogen using 5% NiO—SiO₂ catalyst

| Operating Parameter | Condition |
|---|---|
| Step 1: | |
| Reduction Temperature (° C.) | 700 |
| Concentration CO in Nitrogen (%) | 40 |
| Flow rate of CO gas (mL/min) | 20 |
| Step 2: | |
| Oxidation Temperature (° C.) | 600 |
| Flow rate nitrogen carrier (mL/min) | 10 |

Active phase formed after the reduction reaction of NiO plays an important role in determining the activities of the water splitting reaction for hydrogen production.

TABLE 8
Catalyst activity

| Performance | Dose 1 | Dose 20 |
|---|---|---|
| Hydrogen quantity (μmol) | 9.28 | 7.46 |
| Hydrogen yield (%) | 44.6 | 35.9 |

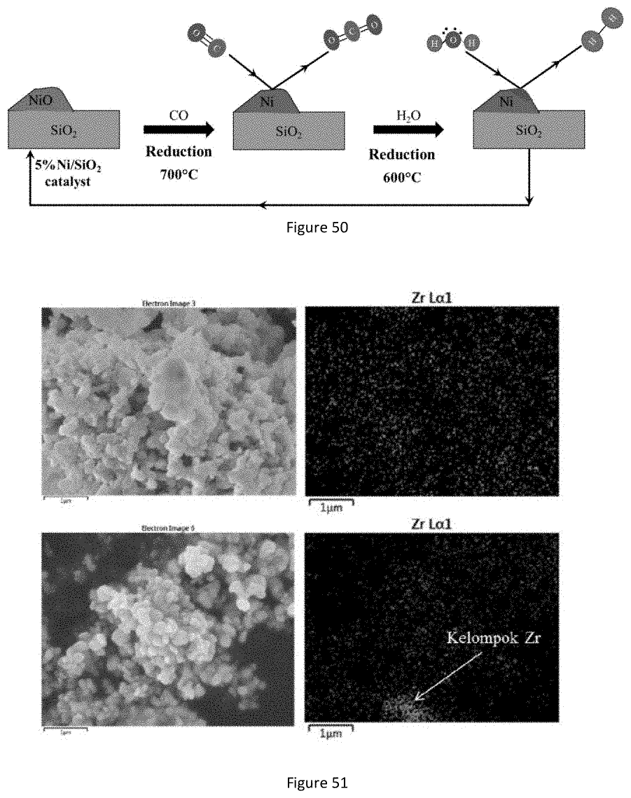

Proposed phases transformation in production of hydrogen via redox reaction is illustrated in FIG. 50.

### Summary

Preliminary studies show through thermodynamic approach, a series of metal oxide were assessed and tested for their reactivity and potential hydrogen production capability under a range of conditions. The thermodynamic data obtained over a selection of metal oxides for their reactivity in both carbon monoxide reduction and oxidation (using water vapour) to produce clean hydrogen. The redox catalysts comprising of Fe₂O₃, WO₃ and NiO were identified to be suitable for further experimental analysis. They were identified to be suitable for production of hydrogen via water splitting process according to thermodynamic consideration.

Addition of Ni promoter to the WO₃ improved redox reactivity compared to unpromoted WO₃, along with increase the reducibility to obtain active sites that able to catalyse the water splitting in the second step of hydrogen production. It is due to the ability of the metal to increase CO adsorption and accelerate the reduction reaction and thus increase the active site quantity to be oxidized during the reaction of water molecules to produce hydrogen. The 15% Ni/WO₃ catalyst system is the best catalyst in producing hydrogen where the active phases or sites WO_{2.72}, WO₂, W, and Ni. However, the optimum parameter reduction and oxidation temperature were at 850° C. and 750° C. respectively which is too high and the catalyst is quite expensive to be applied for industry.

Furthermore, addition of support SiO₂ to the NiO catalyst shows high yield of hydrogen production compared to NiO catalyst alone in the oxidation reaction (water splitting). This is because by adding support will increase the surface area of the catalyst to react with water vapour in producing hydrogen. In this case, the best catalyst in producing hydrogen is 5% NiO—SiO₂ but due to the formation of carbon on the catalyst surface will retard the water splitting reaction if the reaction in excessive CO exposure.

The usage of iron oxide in production of hydrogen via two step reactions is desirable, for its high oxygen storage capacity, relatively low temperature of reduction and re-oxidation which both optimum at temperature 600° C. Based on XRD analysis, active phase formed after the reduction reaction were FeO and Fe which responsible for the hydrogen production activity. Hydrogen production activity for unsupported Fe₂O₃ producing incredible productivity compared to supported Fe₂O₃. As a result, Fe₂O₃ was selected to be used in R2 to produce hydrogen as it is cheap and also widely available.

### Example 4

### Effect of Addition of Zr Promoter on the Reduction and Production of Hydrogen

### Parameters Studies

Metal Zr loading: 1, 5, 3 and 10 wt % Zr on Fe₂O₃(GP) 500 μm
Reduction temperature varied: 500 and 600° C.
Water splitting temperature: 600° C.
Concentration of CO in N₂: 10%

(GP): Grinded Pellets (<500 μm)

(P): Pellets (2-6 mm)

### Catalysts Preparation

The Zr doped iron oxide was prepared by impregnating Fe₂O₃ powder with an aqueous zirconia (III) solution. The amount of Zr was adjusted to be equal to 1, 3, 5 and 10 wt % of Zr metal. The Fe₂O₃ powder was directly impregnated with 50 ml of the corresponding metal cation additives and stirred vigorously for 5 h at room temperature. The impregnated sample was dried at 110° C. overnight and subsequently calcined at 600° C. for 3 h.

The Fe₂O₃ sample with and without zirconia content were denoted as ZrFe₂O₃ and Fe₂O₃, respectively.

### Analysis of Surface Physical Properties Using Isothermal Nitrogen Absorption Technique

TABLE 9
The surface area, volume and pore diameter for addition of Zr
with different percentages which are modified on the Fe₂O₃

| Sample | S_{BET} (m²/g) | V_{Pore} (cm³/g) | D_{Pore} (nm) |
|---|---|---|---|
| Fe₂O₃ | 5 | 0.01 | 11 |
| 3% Zr/Fe₂O₃ | 6 | 0.04 | 23 |
| 5% Zr/Fe₂O₃ | 7 | 0.05 | 27 |
| 10% Zr/Fe₂O₃ | 9 | 0.05 | 28 |
| 15% Zr/Fe₂O₃ | 10 | 0.06 | 22 |

From Table 9, it shows the addition of Zr species on Fe₂O₃ contributes to increase in catalysts surface area and pore volume. Higher surface area might be enhanced catalytic performance in water splitting. While, bigger pore size up to 27 nm can reduce reactant blocking the active pores towards higher activity and stability of the 5% Zr/Fe₂O₃ catalyst.

### Analysis of Surface Morphology and Metal Composition Using FESEM-EDX Technique

From FIG. 51, FESEM images and mapping element show a well disperse Zr element on the metal oxide particles in 5% Zr/Fe₂O₃ catalyst. It was better than other catalyst system with higher loading of Zr promoter (10 wt % and 15 wt %).

### Results and Discussion:

i. Reduction of Metal Oxide (TPR)

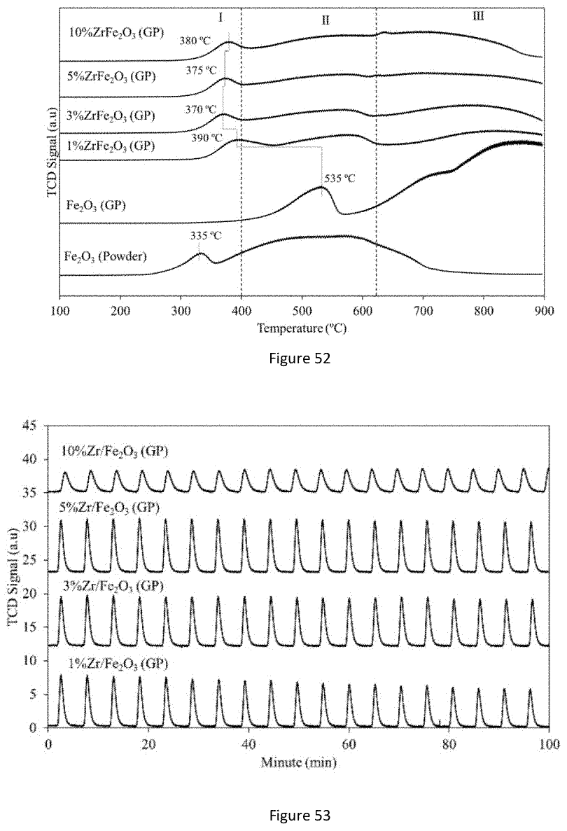

FIG. 52 shows a TPR pattern for non-isothermal reduction of Fe₂O₃ in powder, grinded pellets (<500 μm) and series of Zr doped Fe₂O₃ using CO (10% in N₂) as a reducing agent until 900° C. The TPR profile shows quite similar pattern with one sharp peak at early reduction temperature followed by a broad reduction peak at higher temperature. The lower temperature peak for Fe₂O₃ (powder) samples occur at 335° C., while for Fe₂O₃(GP) at 535° C. which is at higher temperature compared to powder Fe₂O₃.

However, addition of Zr to Fe₂O₃ as a promoter has a positive effect which enhanced the reducibility of Fe₂O₃(GP) as it could shift to lower temperature to 370° C. The first stage of reduction (Fe₂O₃→Fe₃O₄) and this observation is in agreement with Kuo et al. Zr particles are small (micro or nano-sized) and scattered on Fe₂O₃ surfaces making ZrO reduced at temperatures (500-600° C.).

When temperature rise to 600° C., most Fe₃O₄ disappear and start to form FeO phase. However, addition of Zr reduces the production of stable FeO phase at high temperature resulting complete reduction to Fe metal which occur early at 700° C. compared to Fe₂O₃ only which occur at 900° C. The reduction process ends at 700° C. and this explains that 5% ZrFe₂O₃ reduction reaction under (10% in N₂) decreases by 3 steps Fe₂O₃→Fe₃O₄→FeO→Fe.

ii. Water Splitting

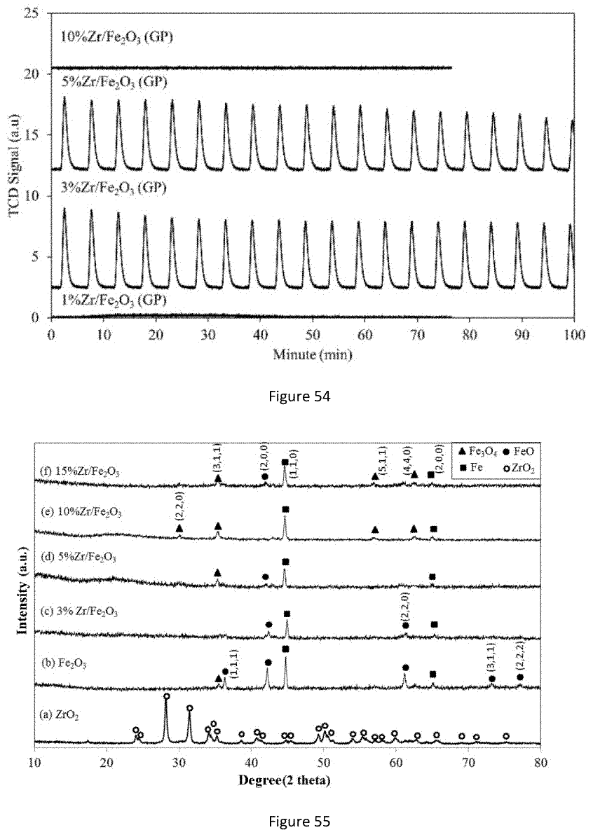

About 0.23 cm³ (10.4 μmol) of water vapour using 0.98 cm³ of sample loops in the N₂ stream dosed for each pulse to the reduced metal oxide to undergo the water splitting reaction (oxidation) to produce hydrogen. FIG. 53 and FIG. 54 shows production of hydrogen of Zr doped Fe₂O₃ series catalyst at temperature 600° C. and 500° C. respectively. 5% ZrFe₂O₃ (GP) catalyst produces higher hydrogen quantity at reduction reaction and oxidation reaction (water splitting) at temperature both at 600° C.

The difference in activity shown in PCWV profile for hydrogen production due to the difference in product of iron oxide produced after reduction reaction. The oxidation of Fe metal to the Fe₂O₄ phase theoretically produce more hydrogen about 80% than if it oxidized to the FeO phase which only 50% hydrogen. The results showed that the percentage of water vapor conversion of Fe₂O₃ alone was lower at 75.2% compared to 5% Zr/Fe₂O₃ (90.4%) as well as the hydrogen quantity produced on the first water vapour injection of only 7.8 μmol compared to 5% Zr/Fe₂O₃ (9.4 μmol). High activity shown by 5% ZrFe₂O₃ catalyst is also contributed by 5% Zr itself when the Zr is involved in the redox reaction to produce hydrogen.

### Determination of Crystalline Properties Using XRD Technique

FIG. 55 shows XRD diffractogram of Fe₂O₃ and Zr/Fe₂O₃ catalyst series with various Zr loading after the reduction reaction using CO (10% in N₂) at 600° C. According to the profile, the reducibility of Fe₂O₃ is increases when the Zr loading decreases. This is in agreement with the TPR profile as the peak III is shifted to the higher temperature when the Zr loading increases.

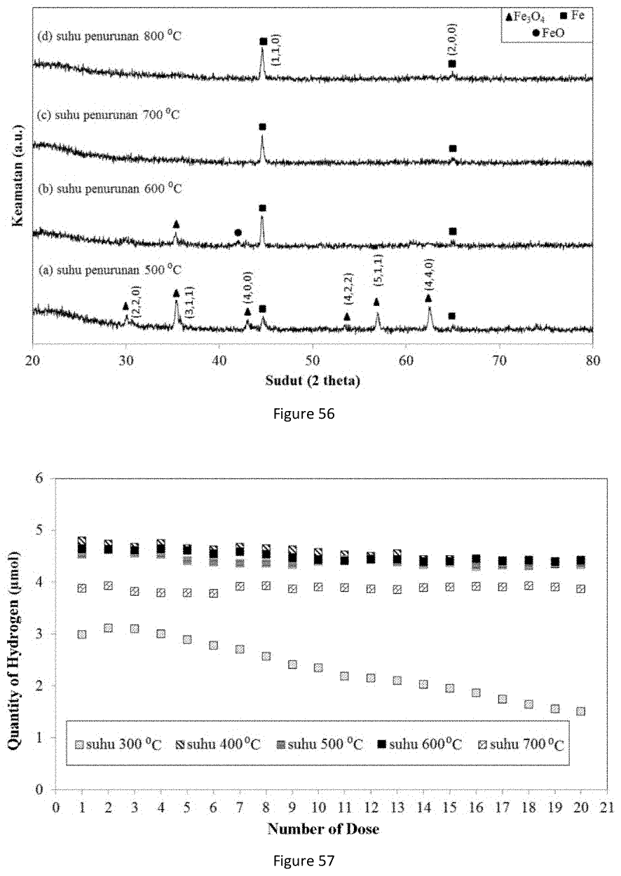

To determine the exact phase changes that occurred during the reduction of 5% Zr/Fe₂O₃ catalysts, the sample after reduction was collected at temperature 500,600, 700 an d 800° C. shown in FIG. 56. Formation of Fe metal phase is observed early at 500° C. This has been proving that Fe₂O₃ also able to direct reduce to Fe without forming Fe₃O₄ phase. When temperatures rise to 600° C., most of Fe₃O₄ peaks disappear and starts the to form FeO phase. However, the addition of Zr has been decreasing the production of stable FeO phase at high temperatures makes the rate the reduction reaction is faster with complete reduction process to the Fe metal occurs as early as 700° C. as compared to the temperature of 900° C. for Fe₂O₃ only. this explains that the reduction reaction 5% Zr/Fe₂O₃ using CO (10% in N₂) is also through 3 step reduction as follow Fe₂O₃→Fe₃O₄→FeO→Fe.

### Hydrogen Production Activities for the Best Catalysts, 5% Zr/Fe₂O₃

FIG. 57 shows the effect of varying temperature on the water splitting (oxidation) reaction to quantity of hydrogen produced. The results show that the effect of the oxidation reaction temperature gives different profile which 5% Zr/Fe₂O₃ catalyst produces the optimum activity. At 400° C., the conversion rate on the first water vapor injection was the highest (46.2%) and is a sharp rise compared to the temperature of 300° C. (28.8%) with the value of hydrogen production quantities is also best viewed at 4.8 μmol compared to 3.0 μmol for 300° C. However, the percentage of hydrogen has decreased slightly at temperature of 500° C. (43.6%) but slightly increased back to 600° C. (44.7%).

When the temperature reaches 700° C. the percentage of water vapor conversion and hydrogen quantity which resulted in low returns (37.4%, 3.9 μmol) and overall its sequence can be summarized as follows: 400° C.>600° C.>500° C.>700° C.>300° C.

TABLE 10
Percentage of hydrogen yield for 5% Zr/Fe₂O₃catalyst at
various temperature of oxidation reaction

| Oxidation | | | |
|---|---|---|---|
| reaction | Percentage of hydrogen production (%) | | |
| temperature | 1^{st} Injection | 10^{th} Injection | 20^{th} Injection |
| 300° C. | 23.0 | 18.0 | 11.6 |
| 400° C. | 36.9 | 35.2 | 33.5 |
| 500° C. | 34.9 | 33.9 | 33.4 |
| 600° C. | 35.7 | 34.1 | 34.1 |
| 700° C. | 29.9 | 30.0 | 29.8 |

Note:
The temperature decrease is maintained at 600° C. under CO (10% in N₂)
The percentage of hydrogen percentage theory: 80%

Percentage of hydrogen yield at varying oxidation temperature can be referenced in Table 10. According to the result, the first water vapor injection gives a similar pattern and can be expressed in descending order as follows: 400° C. (36.9%)>600° C. (35.7%)>500° C. (34.9%)>700° C. (29.9%)>300° C. (23.0%).

a) The Effect of the Decrease Temperature

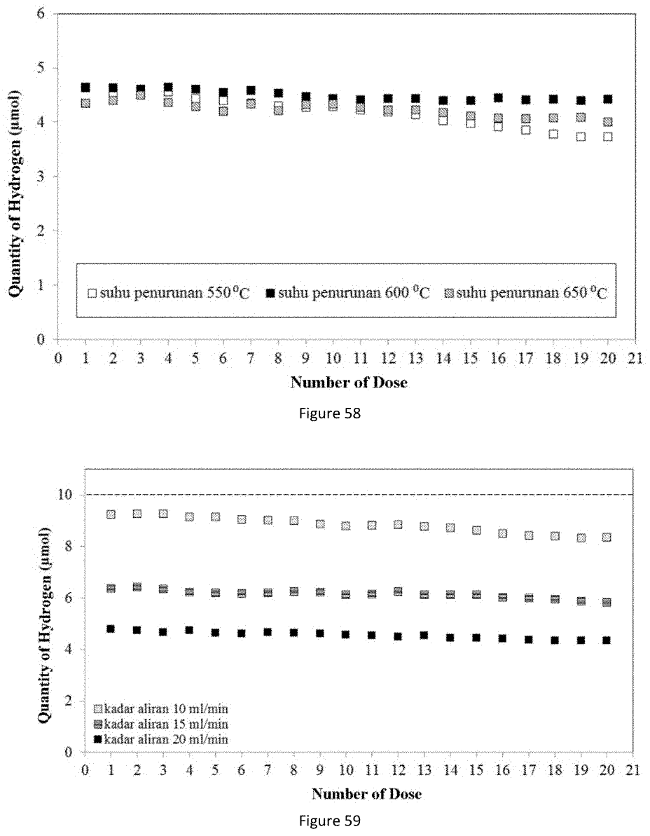

According to the quantity of hydrogen produced as the reduction temperature varied at 550, 600, and 650° C. in FIG. 58, there was found to have a change in hydrogen quantity. The initial injection number does not show significant differences but when the injection number reached the 10th for temperature of 550° C. and 650° C., the amount of hydrogen produced decreases. This situation may be caused the sintering effect that occurs at a temperature of 650° C. Meanwhile, reduction temperature at 550° C. shows less active phase that can contributed to hydrogen production.

TABLE 11
Percentage of hydrogen yield for 5% Zr/Fe₂O₃catalyst at
various temperature of oxidation reaction

| Reduction reaction | Percentage of hydrogen production (%) | | |
|---|---|---|---|
| temperature | 1^{st} Injection | 10^{th} Injection | 20^{th} Injection |
| 550° C. | 35.7 | 33.0 | 28.7 |
| 600° C. | 36.9 | 35.2 | 33.5 |
| 650° C. | 33.5 | 33.4 | 30.8 |

ote:
The temperature decrease is maintained at 400° C. under CO (10% in N₂)
The percentage of hydrogen percentage theory: 80%

The effect of reduction temperature to the percentage of water vapour conversion and the percentage of yield hydrogen shown in Table 11. 5% Zr/Fe₂O₃ catalysts can be summarized according to descending order according to the first water vapor injection as follows: temperature decreases 600° C. (36.9%)>550° C. (35.7%)>650° C. (33.5%).

b) The Effect of Carrier Gas Flow

Flow rate of carrier gas (nitrogen) was varied at 10, 15 and 20 mLmin−1 in water splitting (oxidation) reaction in order to investigate the catalytic activity with their contact time were 0.5, 0.33 and 0.25 min respectively. The resulting of quantity of hydrogen in FIG. 59, shows that flow rates are seen to have a significant influence on the catalysts activity especially when the carrier gas flow rate is lowered. Nitrogen flow rate at 10 mLmin−1 produced the optimum hydrogen quantity of 9.4 μmol compared to the flow rate of 15 mLmin−1 (6.4 μmol) and 20 mLmin−1 (4.6 μmol).

TABLE 12
Percentage of hydrogen produced
for 5% Zr/Fe₂O₃catalyst at various flow rate

| Flow rate of carrier | Percentage of hydrogen prodcution | | |
|---|---|---|---|
| gas (mLmin⁻¹) | 1^{st} Injection | 10^{th} Injection | 20^{th} Injection |
| 10 | 72.3 | 67.7 | 64.2 |
| 15 | 48.9 | 47.2 | 44.8 |
| 20 | 36.9 | 35.2 | 33.5 |

Note:
The reduced temperature is 600° C. and the oxidation temperature is 400° C.
Note:
The percentage of hydrogen percentage theory = 80%

According to the percentage of water conversion and the percentage of hydrogen produces to the rate of flow carrier gas, can be summarized as follows of 1^{st} injection of water vapor (10 mLmin−1 (72.3%)>15 mLmin−1 (48.9%)>20 mLmin−1 (36.9%) and shown in Table 12.

### Reagent Studies for Redox Reaction of Water Molecules for Hydrogen Production

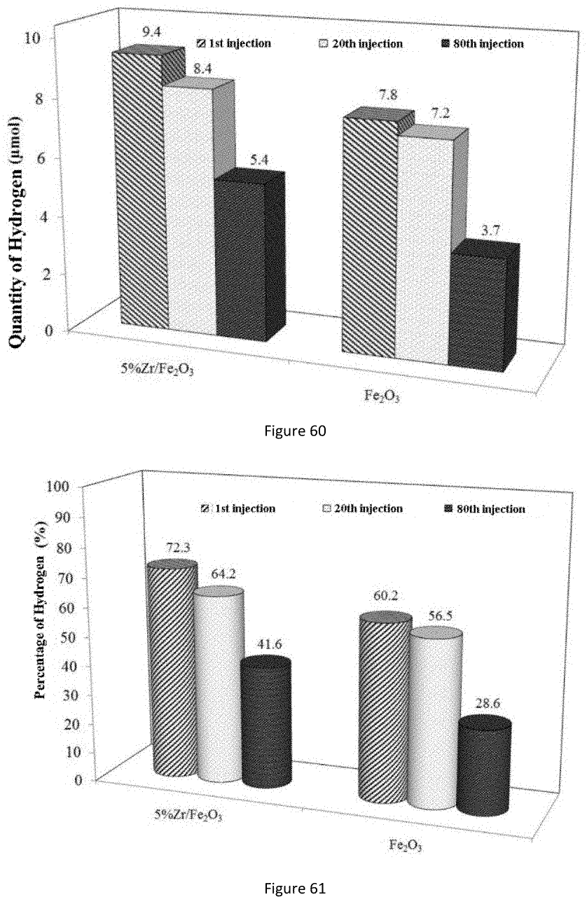

FIG. 60 shows the comparison of quantity of hydrogen produced by 5% Zr/Fe₂O₃ and Fe₂O₃ catalysts at reduction and oxidation temperature 600 and 400° C. respectively for 80 times water vapour injection. Results found that the quantity of hydrogen produced at the first water vapor injection of Fe₂O₃ catalyst is 7.8 μmol compared to 5% Zr/Fe₂O₃ is 9.4 μmol. The value is getting lower with the increase in number of injections and when both catalysts are given 80 times of amount of water vapor injection value the hydrogen quantity becomes 3.4 and 5.4 μmol at the last injection respectively. 5% Zr has significantly affected the activity of Fe₂O₃ catalysts up to percentage the hydrogen produced to 72.3% approximates the theoretical value (80%) compared to Fe₂O₃ catalyst only (60.2%), an increase of 12.1%. In addition, hydrogen production activity from 5% catalyst Zr/Fe₂O₃ found to survive, although as many as 80 times the amount of water vapor injection has been given, the percentage value of the hydrogen yield decreases to half compared to the theory of 41.6% and this shows that hydrogen can be produced estimated to exceed 160 times of water vapor injection. FIG. 61 shows in details of the quantity of hydrogen percentage produced for 5% Zr/Fe₂O₃ and Fe₂O₃ catalyst on reduction temperature at 600° C. and oxidation temperature of 400° C.

TABLE 13
Operational conditions of hydrogen production redox
reactions for 5% Zr/Fe₂O₃ catalytic regeneration studies

| Parameter | Quantity |
|---|---|
| Flow rate for reduction reaction | 20 mLmin⁻¹ |
| Flow rate for oxidation reaction | 10 mLmin⁻¹ |
| Temperature for reduction reaction | Not isothermal (25-600° C.; 10 min⁻¹) |
| (cycle 1) | |
| Temperature for oxidation | Not isothermal (400-600° C.; 10 min⁻¹) |
| reaction/regeneration (cycle 2-10) | |
| Temperature for reduction reaction | 600° C. |
| Number of times the water vapour | 80 |
| injection for each redox cycle | |
| The number of times the redox cycle | 10 |

Operational conditions of hydrogen production redox reactions for 5% Zr/Fe₂O₃ catalytic regeneration studies shown in Table 13.

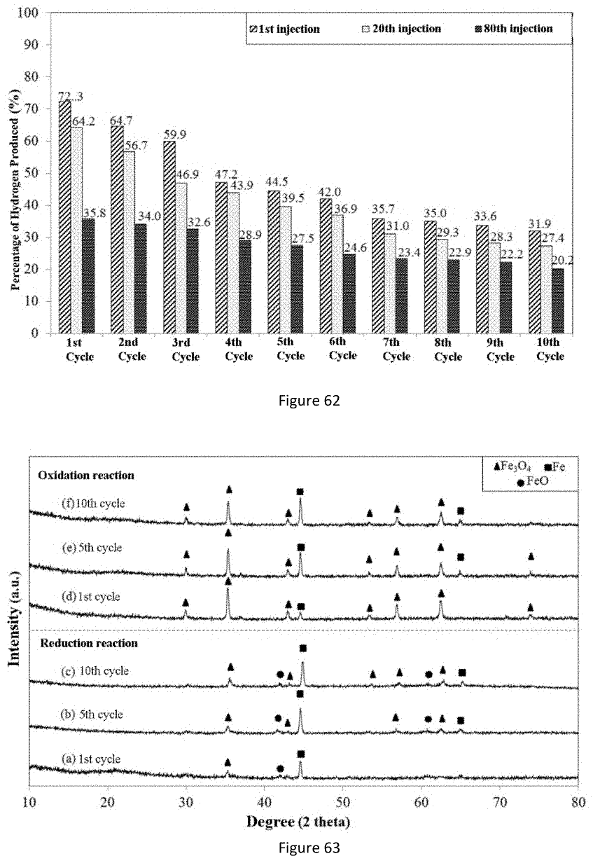

Regeneration study of Zr/Fe₂O₃ catalyst initiated with reduction reaction at 600° C. using (10% CO in N₂) followed by an oxidation reaction by water vapour for 80 times at 400° C. After the oxidation reaction, the catalyst streamed with CO reduction from 400° C. up to 600° C. before further oxidation reaction take place. The same method is repeated up to 10 redox cycles and percentages water vapor conversion has been shown in FIG. 62. According to the result, as the number of redox cycle increase, the conversion percentage decreases up to 50% between the first water vapor injection (90.4%) at cycle 1 and the first water vapor injection for Cycle 10 (39.9%) or equivalent 720^{th} injection.

XRD analysis of 5% Zr Fe₂O₃ after reduction and oxidation reaction at the 80th of water vapor injection for cycle 1, cycle 5 and 10 cycle shown in FIG. 63. Based on XRD diffractogram for all three selected redox cycle, Fe and FeO active phases have been oxidized to Fe₃O₄ and there is unstable Fe metal remain. The Fe metal indicates that the oxidation reaction can still be continued. 5% Zr/Fe₂O₃ catalyst regeneration using CO at non-isothermal temperature (400° C.-600° C.) was found to be effective when diffractogram for the 5th and 10th cycles show the peak of Fe₃O₄ diffraction to getting lower and some Fe₃O₄ peaks disappeared transform to FeO and Fe metal phase. All direct diffractogram does not indicate the peak of the Zr indicates the probability Zr is stretched evenly or Zr too little to detect using XRD. This up to 10 cycles of no formation of carbide species allowed re-generation of the catalysts are observed using relatively low CO concentration (10% in N₂).

### Summary

5% ZrFe₂O₃ catalyst was able to generate hydrogen at the best condition to achieve 90.4% conversion of water vapour to hydrogen with the hydrogen percentage yielded to reach 72.3% which is very close to theoretical value (80%).

5% ZrFe₂O₃ catalyst system using 10% CO in N₂ non-isothermal at 600° C. able to produce hydrogen up to 10 continuous redox reaction cycles where nearly 800 times the water vapour injection has been provided without indicating the loss of significant activity.

1. An impregnated catalyst composition for production of pure hydrogen comprising:
10 wt %-50 wt % metal oxide;
1 wt %-15 wt % promoter; and
60 wt %-90 wt % support material.

2. The impregnated catalyst composition for production of pure hydrogen according to claim 1, wherein the metal oxide is selected from all the d block elements.

3. The impregnated catalyst composition for production of pure hydrogen according to claim 1, wherein the promoter is selected from zirconium oxide, nickel oxide, molybdenum oxide, niobium oxide, ruthenium oxide, rhodium oxide, palladium oxide, argentum oxide, chromium oxide, vanadium oxide, manganese oxide, iron oxide, copper oxide, zinc oxide, iridium oxide, tungsten oxide, platinum oxide and gold oxide.

4. The impregnated catalyst composition for production of pure hydrogen according to claim 3, wherein the promoter is in the form of nitrate salt.

5. The impregnated catalyst composition for production of pure hydrogen according to claim 1, wherein the support material is selected from the list of aluminium oxide, silica oxide, zirconium oxide, zinc oxide and tin oxide.

6. The impregnated catalyst composition for production of pure hydrogen according to claim 1, wherein the impregnated catalyst yields pure hydrogen ranging from 58%-73%.

7. A method of preparation of an impregnated catalyst for pure hydrogen production (10) comprising steps of:
(i) providing a single metal oxide powder, promoter and support material (11);
(ii) adding the metal oxide powder, the promoter and the support material into an aqueous salt with a corresponding metal cation to form a mixture (12);
(iii) stirring the mixture to form an impregnated catalyst (13); and
(iv) drying and calcining the impregnated catalyst (14).

8. The method of preparation of an impregnated catalyst for pure hydrogen production according to claim 7, wherein the metal oxide in step (11) is selected from all the d block elements.

9. The method of preparation of an impregnated catalyst for pure hydrogen production according to claim 7, wherein the promoter in step (11) is selected from zirconium oxide, nickel oxide, molybdenum oxide, niobium oxide, ruthenium oxide, rhodium oxide, palladium oxide, argentum oxide, chromium oxide, vanadium oxide, manganese oxide, iron oxide, copper oxide, zinc oxide, iridium oxide, tungsten oxide, platinum oxide and gold oxide.

10. The method of preparation of an impregnated catalyst for pure hydrogen production according to claim 9, wherein the promoter in step (11) is in the form of nitrate salt.

11. The method of preparation of an impregnated catalyst for pure hydrogen production according to claim 7, wherein support material in step (11) is selected from the list of aluminium oxide, silica oxide, zirconium oxide, zinc oxide and tin oxide.

12. The method of preparation of an impregnated catalyst for pure hydrogen production according to claim 7, wherein the stirring step in step (13) is conducted for 4-5 hours at 40° C.-80° C.

13. The method of preparation of an impregnated catalyst for pure hydrogen production according to claim 7, wherein the drying step in step (14) is conducted at a temperature of 110° C.-150° C. for overnight.

14. The method of preparation of an impregnated catalyst for pure hydrogen production according to claim 7, wherein the calcining step in step (14) is conducted at a temperature of 400° C.-600° C.

15. The method of preparation of an impregnated catalyst for pure hydrogen production according to claim 7, wherein the impregnated catalyst is prepared with a ratio of 10 wt %-50 wt % metal oxide; 1 wt %-15 wt % promoter-metal oxide; and 60 wt %-90 wt % metal oxide-support material.

16. The method of preparation of an impregnated catalyst for pure hydrogen production according to claim 7, wherein the produced impregnated catalyst yields pure hydrogen ranging from 58%-73%.

17. A method for producing pure hydrogen (20) comprising the steps of;
reacting an impregnated catalyst according to claim 1 with water to form metal oxide and produce selectively pure hydrogen (21); and
reacting the metal oxide with carbon monoxide to regain the impregnated catalyst for reuse; wherein the steps occur simultaneously within at least a reactor, thereby the selectively pure hydrogen is collected at a temperature range of 400° C.-800° C. (22).

18. Use of the catalyst according to claim 1 for pure hydrogen production wherein reaction temperature is reduced by 1 to 2 folds.

19. Use of the catalyst according to claim 6 for pure hydrogen production wherein the reaction temperature ranges from 400° C.-800° C.

20. A method for producing pure hydrogen (20) comprising the steps of,
reacting an impregnated catalyst according to claim 2 with water to form metal oxide and produce selectively pure hydrogen (21); and
reacting the metal oxide with carbon monoxide to regain the impregnated catalyst for reuse; wherein the steps occur simultaneously within at least a reactor, thereby the selectively pure hydrogen is collected at a temperature range of 400° C.-800° C. (22).

21. A method for producing pure hydrogen (20) comprising the steps of,
reacting an impregnated catalyst according to claim 3 with water to form metal oxide and produce selectively pure hydrogen (21); and
reacting the metal oxide with carbon monoxide to regain the impregnated catalyst for reuse; wherein the steps occur simultaneously within at least a reactor, thereby the selectively pure hydrogen is collected at a temperature range of 400° C.-800° C. (22).

22. A method for producing pure hydrogen (20) comprising the steps of,
reacting an impregnated catalyst according to claim 4 with water to form metal oxide and produce selectively pure hydrogen (21); and
reacting the metal oxide with carbon monoxide to regain the impregnated catalyst for reuse; wherein the steps occur simultaneously within at least a reactor, thereby the selectively pure hydrogen is collected at a temperature range of 400° C.-800° C. (22).

23. A method for producing pure hydrogen (20) comprising the steps of,
reacting an impregnated catalyst according to claim 5 with water to form metal oxide and produce selectively pure hydrogen (21); and
reacting the metal oxide with carbon monoxide to regain the impregnated catalyst for reuse; wherein the steps occur simultaneously within at least a reactor, thereby the selectively pure hydrogen is collected at a temperature range of 400° C.-800° C. (22).

24. Use of the catalyst according to claim 2 for pure hydrogen production wherein reaction temperature is reduced by 1 to 2 folds.

25. Use of the catalyst according to claim 3 for pure hydrogen production wherein reaction temperature is reduced by 1 to 2 folds.

26. Use of the catalyst according to claim 4 for pure hydrogen production wherein reaction temperature is reduced by 1 to 2 folds.

27. Use of the catalyst according to claim 5 for pure hydrogen production wherein reaction temperature is reduced by 1 to 2 folds.
